(19) United States
(12) Patent Application Publication
(10) Pub. No.: US 2015/0203026 A1
(43) Pub. Date: Jul. 23, 2015

(54) Position and pathway lighting system for a vehicle or combination of vehicles sides undersides rear or trailing wheels and rear or trailing body portion

(71) Applicant: Todd A Schotanus, Bakersfield, CA (US)

(72) Inventor: Todd A Schotanus, Bakersfield, CA (US)

(21) Appl. No.: 14/594,815

(22) Filed: Jan. 12, 2015

Related U.S. Application Data
(60) Provisional application No. 61/930,434, filed on Jan. 22, 2014.

(51) Int. Cl. B60Q 1/24; B60Q 1/00; F21V 29/70; F21K 99/00

(52) U.S. Cl. CPC B60Q 1/24; F21K 9/50; B60Q 1/0005; F21V 29/70; B60Q 1/0076; F21Y 2101/02

(57) ABSTRACT

The invention describes a lighting system apparatus intended to increase safety during operation of mainly large or lengthy vehicles and combination vehicles in darkness and poor visibility. The lighting system is comprised of a single or plurality of light sources designed for vehicular use and housed in a durable thermally conductive material having a lens through which light is projected. Said light source housings are attached to the vehicle whereby, when actuated by a controller, sufficient illumination is directed onto the specific areas on the vehicle(s) and ground surface peripheral to said vehicle or combination of vehicles at one or more areas along the sides and rear or trailing portions to the extent that the driver can more safely control said vehicle(s) because of increased visual cognition of the aforementioned areas via the rear-view mirrors. Persons proximate are also more aware of said vehicle(s) position and pathway by means of said illumination and can more readily avoid dangerous contact.

### CROSS-REFERENCE TO RELATED APPLICATIONS

Application No. 61/930,434 Filed on Jan. 22, 2014 by: Schotanus, Todd A. California, USA

### TECHNICAL FIELD OF THE INVENTION

This invention relates generally to safety and illumination systems for vehicles and more specifically, for improving visual cognition and control during darkness and poor visibility primarily for drivers of large and lengthy vehicles by means of illumination provided by specially positioned and controlled light sources. This invention is particularly adaptable for incorporation into or onto the bodies and/or framework of both “on-road” and “off-road” vehicles having wheels or tracks.

Unlike the traditional role of headlights which are employed to illuminate what is ahead, this invention is employed primarily to improve safety by illuminating the dark areas on the road surface and peripheral space that is within the pathway or zone of the sides, rear or trailing portion of a vehicle or combination of said. The areas illuminated include all or part of the rear axle area proximate to the wheels, the sides, and the end portion of the body or framework. Said illumination from the invention is intended to be sufficient to the point that the driver may make adequate visual assessment of said areas via the side mounted rear-view mirrors, and also sufficient that persons proximate are clearly alerted to the vehicle's position and pathway. This then creates a new awareness and subsequent reaction time ordinarily not possible during which corrections to course by either party can be taken in order to avoid accidental contact thus greatly mitigating the opportunity for property damage or injury. This is most useful to any combination of vehicles but is particularly useful to the largest and most lengthy single vehicles, or combinations of vehicles, such as buses or tractor-trailers as need would have it due to their unusual and challenging size and handling characteristics.

### BACKGROUND OF THE INVENTION

The instances of contact and subsequent damage or injury caused by the rear area of lengthy or larger vehicles in particular, whether in traffic or at other times of operation has long been an area of heightened concern and study. This problem stems from the simultaneous difficulty on the part of both the driver and persons proximate in ascertaining the position and pathway of the trailing portion of the vehicle, especially in darkness. The challenge has prompted many responses from talented inventors and others.

Take for example side or rear mounted cameras that help to eliminate blind-spots during a lane change, or the illuminated side mirrors on automobiles that create a well lit safety zone for entry into the vehicle while also alerting motorists or others by its bright signal flash. Also, special lanes for bicyclists have been adopted and large “right turn” warning signs on the rear parts of lengthy vehicles have been utilized. In fact, due to collisions with the sides of tractor-trailers in poor visibility, a law was enacted making DOT reflective tape mandatory along the sides of such vehicles. All in an effort to help increase visual awareness and prevent accidents and yet to a large degree, the problem remains. While these examples of prior art are creative and effective to a point, there remains the current problem of the inability to visually ascertain the position and pathway of the rear axles (wheels), sides and rear of these lengthy vehicles in total darkness and times of poor visibility, the very conditions in which these unfortunate accidents are likely to occur. This invention seeks to address it directly.

Accordingly, the invention creates ample illumination to the areas mentioned and achieves the goal of creating a subsequent reaction time that is not present currently. The reaction time will serve to give the driver and other parties, such as a motorist, bicyclist or pedestrian, advance warning of potential impending contact. This is a proactive approach to the visibility problem and results in improved awareness, control and safety. As mentioned, drivers must maneuver and navigate a bus, tractor-trailer or any lengthy trailer for that matter by relying on the side mounted rear-view mirrors, there is no other practical way. This can be difficult at times considering that the rear axles or trailing portion of such vehicles can be 70 feet or more behind the driver's seat. During the day the driver can readily identify most everything around their vehicle or combination of vehicles. In darkness or poor weather conditions however, this is done more by “feel” and experience than by precise visual cognition as to the clear tracking direction of the rear of the vehicle. In other words, as a driver operating at night without light to these areas, you simply cannot see any part of the vehicle in your mirrors apart from a few amber marker lamps on the vehicle's body. You cannot see whether you are turning your vehicle wide enough to avoid having your trailing axles make contact with the curb, or the body scrape a pole etc. There may also be debris, a deep hole, or an unseen person in that pathway. Anyone who has pulled a lengthy trailer at night has experienced this. This can be nerve racking especially when the road or streets are completely dark or suddenly become less accommodating for some reason such as encountering obstacles or bad road conditions etc. The invention provides the advance illumination and warning needed to safely navigate the rear of the vehicle(s) through the area.

A driver of a city bus is presented with other uniquely difficult challenges in addition to those just mentioned when navigating the bus through city traffic. The driver must operate with the interior lights illuminated during the night causing a great deal of glare inside the bus because the glass reflects the light. It is somewhat difficult to see outside the bus to begin with and this just makes it worse, especially where street lighting is poor. Add to this the presence of a random bicyclist passing unexpectedly along with constant interaction with moving pedestrians, some of which are distracted, and you have unpredictable and potentially dangerous situations. Here also, the lighting system applied to the sides of the bus, makes both side areas brightly lit enabling the driver to clearly see everything along the sides of the bus as visible through the rear-view mirrors.

It takes only a moment to perform an internet search in order to learn that tragic accidents between buses and pedestrians or bicyclists occur fairly often nationwide. A lack of precise visual identification of the trailing portion of the vehicle, the rear wheels their pathway, makes it easy for the both the driver and the pedestrian at the curb to be simultaneously caught unaware of the position of the other relative to the position of the approaching off-tracking rear axle(s). During a turn, in a split-second of time the driver may think the way is clear because it appeared so in his mirrors. The driver cannot see details and may miscalculate the turn due to the lack of light, or fail to see the person who has stepped into harm's way just as the rear of the vehicle completes the turn. Without illumination the driver may not stop in time. This is because he has not seen in time. This is to demonstrate that the lighting system provides response or reaction time as a result of the illumination.

Now from the pedestrian's viewpoint, the off-tracking characteristic of the bus or tractor-trailer may catch them by surprise when it is dark. Most persons are not anticipating the fact that the rear part is turning on a different track or pathway than did the front of the bus or tractor-trailer, which is to say that although the front passes a good distance away, the rear axle area passes the person much more closely, even right up to the edge of the curb, or over the curb. It is not surprising then that the potential for unintended contact with a bystander is even greater when that person is distracted or perhaps listening to a music device, texting, or engaged in cell phone conversation while standing at a curb or near a place where these types of vehicles routinely pass. Children also are vulnerable to being caught by surprise in such a moment. Having an advance flood of light onto that area proximate to the trailing axle(s) visually assists the driver and captures the attention of anyone in the pathway.

Another very common problem is that of property damage resulting in tens of millions of dollars in losses nationally. Drivers pull out in the darkness or back up and inadvertently scrape or crush something. This problem is of course greatly reduced by the implementation of this invention because of the improved illumination. Further, another problem encountered by all lengthy on road vehicles is “curbing” or tire side-wall damage. This is damage caused to the trailing axle's tire sidewalls by rubbing them against the curb repeatedly. It can deteriorate the tire strength over a short time and lead to blow outs. On tractor-trailers specifically, the extreme weight of the trailer pressing the tire hard against the curb can cause a rupture at that very moment especially during extreme hot or cold weather. This of course happens during the day to the less skilled driver, but it can happen at night to even the best driver. It is a prevalent problem common to all freight haulers adding to nationwide losses in the tens of millions per year annually. The lighting system greatly mitigates this as well.

### BACKGROUND AND FIELD OF USE CONTINUED

Although this lighting system invention is practical and helpful in a multitude of everyday circumstances as encountered by drivers of nearly all vehicles, clearly one of the on-highway vehicle applications of the lighting system that is among those who derive the most benefit from the invention are tractor-trailer and combination vehicles in general. The tractor-trailers can be in combinations of two, three or even four total vehicles which are quite lengthy. Because of their size, weight and very high degree of exposure to traffic while in service for some 10 to 24 hours per day, in every possible type of weather and road condition, the lighting system is clearly a great improvement to the tractor-trailer.

Additionally, it needs to be mentioned that at times drivers of automobiles inadvertently enter the poorly defined space under the tractor-trailer. This area can be from 26 to 50 feet of open area beneath the trailers. The height of the trailer floor is tall enough that smaller cars can easily get wedged in resulting in serious damage and injuries. This generally occurs when the operator of the tractor-trailer fails to see the quicker passenger vehicle when it passes on the right at highway speeds. The automobile is usually half way around when the truck driver is returning to the right lane not seeing the automobile. This also happens during right turns. The driver of the automobile should never do this because it is much more difficult for the truck driver to catch sight of them in the right rear-view mirror. Because of this problem, it is common that commercial trailers display warning stickers on the right rear doors of the trailer that are meant to discourage any passing on the right. In any case, it still happens and the lighting system mounted to the trailer at specific locations serves to mitigate this problem by the warning given to the driver of the passenger vehicle when the lighting system is activated in conjunction with the tractor-trailer turn signal. The subsequent illumination of the undersides and axle areas creates immediate visual contact and higher awareness of the position and direction of movement of the trailer portion and discourages close proximity.

Aside from the increased safety enjoyed by operators of the full range of tractor-trailers and buses, a variety of other areas of vehicle operation are foreseen to be made safer as well. Vehicles like construction and earth moving equipment, super transfer mining trucks, farm implements, cranes and special vehicles such as military wheeled or track vehicles stand to be improved as well, in varying ways by various embodiments.

In many work environments like mining or in military deployment for example, the level of activity is extraordinary in that persons and equipment are bustling about in every direction without the benefit of traffic control measures that we take for granted in our cities or on highways. The occurrences of nighttime contact involving objects or persons with both wheeled and tracked vehicles are prevalent but largely unreported. These nighttime activities combining busyness with clouds of dust, poor light, and little external coordination make for the potential of such accidental events and the statistics show as much.

With regard to the use of the invention on common automobiles, if safety was the metric exclusively used to quantify the value of this system, automobiles would be viewed as being improved to a much lesser degree. They are quite small by comparison to the vehicles described earlier and relatively simple to drive. The lighting system is still beneficial however in that when light sources are properly integrated into the body near the rear wheels or in that general area on each side of the automobile, the driver can determine by the illumination, how close the wheels are to a curb or object as seen in the side mirrors. The benefit here is more limited in that this invention is helpful mainly to assist the driver in parking/backing etc., in order to avoid damage from the curb or wall to the wheels and sides of the vehicle. It is reasonable to assume however that it would also be helpful in providing greater awareness to those in proximity to the automobile.

In conclusion, the lighting system invention detailed herein is created for the purpose of improving safety by providing the driver of a vehicle or combination of vehicles the ability to more safely and skillfully guide and control said vehicle(s) due to the new illumination generated onto crucial areas as visible to the driver via the side mounted mirrors. The second benefit derived from the wheel and/or track lighting system is one of vastly improved safety for persons proximate because of improved visual identification by said persons as to the position, motion and pathway of the sides, rear portion and rear axle areas of wheeled vehicles and ends of tracked vehicle. This common purpose and benefit is universal to all the various embodiments despite differences between embodiments.

### SUMMARY OF THE INVENTION

This invention is intended to provide improved safety as pertaining to vehicular operation by supplying an intense field of light from one or more light sources particularly adapted for use at one or more locations along the vehicle's sides, rear axle area, and the rearmost body corners. Said light sources thus create early-warning and increased safety zone by adequate illumination so that the driver may visually ascertain and identify, by means of the side rear-view mirrors, the road surface and area proximate to such, in order to avoid objects or persons proximate. At the same time, said illumination also indicates to persons proximate the precise position and pathway of the body sides, wheels and or rear portion of the vehicle in order to avoid accidental contact.

This is achieved with the illumination provided by one or more weather resistant light sources specially mounted onto or integrated into the vehicle's body or framework and positioned in such a way to provide said intense field of generally downward with peripheral illumination onto the road surface, in the areas aforementioned.

One or more methods for controlling or activating the lighting system invention can be utilized separately or jointly. The preferred methods are given here. Actuation may be initiated in conjunction with the turn signal or hazard flasher circuit when either is in operation. In this configuration a controller/relay supplies power to the lighting system light sources via a direct current line from the vehicle battery or by an alternative constant power supply source (most likely the marker light or headlamp circuit) once the controller has been “triggered” by the use of the turn signal or hazard flashers. The system light sources will remain “on” until the trigger source is cancelled. Said light sources may also be actuated independently by a dedicated independent switch or plurality of switches whereby direct current is supplied to one or more of said light sources independently if so desired. Additionally, the lighting system may be actuated by means of a motion-detection switch that is positioned in such a way and in such a desired location on the vehicle(s) in order to automatically actuate the light sources upon the detection of any object, person or vehicle within the preset range of the sensor, then cancelling once the pre-set time has expired in the controller. In addition to these methods, the use of a photocell photoelectric switch that actuates the desired light sources upon a detected absence of light may also alternatively utilized to supply continuous current to the lighting system if desired by the user. Other methods including wireless transceivers can also be utilized to control the light sources and lighting system as a whole but could be less desirable due to cost, complexity, and interference problems.

Another aspect of the invention is that the system light sources are alternatively repositionable by means of a position adjustment mechanism whereby the field of light can be redirected at will by the user if so desired. This feature enables greater flexibility in a situation where the conditions around the vehicle have changed. The light source housings themselves may be fitted with said external position adjustment mechanism or it may be “built into” the body or framework of the vehicle by means of a “form-specific” housing that contains the flood light source and its internal components and has conformity of shape and contour as to blend with the external or surrounding body style and has also an integrated position adjustment mechanism such as a “ball and socket” style housing and mounting parts which enable a “swiveling motion” for the light sources with pre-set drag tension, manual tension or servo controller for movement and holding of position.

In both “form-specific” and “non form-specific” types of the light system, the addition of a “glare-shield” component may be included when necessary, to control direct visual exposure to the light intensity by others proximate, especially motorists, depending upon location of mounting of said light sources. Said glare-shield may be constructed of a thin metallic, polymeric or other suitable material and be disposed at the outermost portion of the light source housing. It may optionally be an entirely separate component attached to the vehicle or framework but not to the light source housings themselves. Alternatively, the housing itself may have the reflective material containing the desired light sources mounted within it in an uneven way that is offset and angled away from the housing lens so that part of the field of illumination is interfered with by the edge of the light source housing itself, thus becoming a glare-shield in practice.

According to another embodiment and unusual utilization of the invention, the flood light sources are used also to illuminate the vehicle's front tires also. This departure from the stated purpose of the invention, (that being the illumination of the sides and or trailing portion) is generally only for a specialty use such as for “off-road” earthmoving equipment, mining trucks and military vehicles. In such applications, the light sources are mounted to brackets proximate to all the tires. On a track vehicle, one or more of the light source housings are mounted into the debris shields located over each end of the leading edges of the tracks themselves, front and rear. In this way persons proximate these types of vehicles can clearly discern because of the ample illumination what the position, motion, and pathway of the vehicle is, even if the driver is unaware of the presence of other persons or vehicles because of lack of driver visibility due to the unusually large size or configuration of the vehicle. In this way the intended purpose of the invention is achieved although the standard areas of use is unique to the usual areas of usage, that being the sides and rearward to end areas.

### BRIEF DESCRIPTION OF DRAWINGS AND PREFERRED EMBODIMENTS

FIG. 1 is a left side and front perspective elevation view of a lengthy combination vehicle “off-tracking” and the subsequent potential contact with a pedestrian is depicted. Several preferred mounting locations for the lighting system are indicated also.

FIG. 2 is a top view of a combination vehicle turning to further illustrating off-tracking. The light system mounting locations and peripheral field of illumination is indicated.

FIG. 3 is a bottom view plan style illustration of three preferred mounting locations for light sources. There are two light sources per location.

FIG. 4 is a right side and rear perspective elevation view of a turning combination vehicle to further illustrate off-tracking from a different viewpoint. Preferred areas of intended downward and peripheral illumination are indicated.

FIG. 5A is a partial left side elevation view of a first preferred light source embodiment with adjustable light source housing with glare shield mounted to a commercial trailer.

FIG. 5B is a partial left side bottom view of the preferred light source embodiment of FIG. 5A. (FIGS. 18A and 18B are the enlarged illustrations of the embodiment of FIGS. 5A and 5B)

FIG. 6A is a partial left side elevation view of a second preferred light source embodiment affixed to the sliding axle carriage of a commercial trailer by means of a support component.

FIG. 6B is a partial left side bottom view of the second preferred embodiment of FIG. 6A.

FIG. 7A is a partial left side elevation view of a third preferred light source embodiment with no moving parts, rather having numerous fixed light sources mounted between the floor supports of a commercial trailer.

FIG. 7B is a partial left side bottom view of the preferred embodiment of FIG. 7A.

FIG. 8A is a partial left side elevation view of a fourth preferred light source embodiment with no moving parts, rather having “continuous strip” style light sources. A spread axle commercial trailer is depicted.

FIG. 8B is a partial left side bottom view of the embodiment of FIG. 8A.

FIG. 9A is a partial left side elevation view of a fifth preferred light source embodiment having a tilting mechanism for directing fore or aft illumination. A spread axle commercial trailer is depicted.

FIG. 9B is a partial left side bottom view of the embodiment of FIG. 9A.

FIG. 10A is a distant right side elevation view of either the sixth or seventh preferred light source embodiments, FIGS. 11 and 12, which are form specific and are demonstrated in use as part of the bus's body at its sides. (The protruding or recessed embodiments appear and function essentially the same from a distance so the illustration is used for both.)

FIG. 10B is a top view of FIG. 10A illustrating the general desired side zones of illumination generated by the light source embodiments like those of FIG. 11 or 12.

FIG. 11 is a perspective side view of the sixth light source embodiment that protrudes and is form-specific. It is part of the body of the vehicle and is intended for various uses as demonstrated in FIGS. 10A, 10B, 13, 14, 21A, 21B, 23A and 23B. It is a general example of protruding, not a final and completely specific design.

FIG. 12 is a perspective side view of the seventh light source embodiment of the invention which is alternatively recessed, form-specific, part of the vehicle body, and is intended for various potential use as demonstrated in FIGS. 1, 10A, 10B, 13, 14, 19, 20, 21A, 21B, 23A, and 23B. This is a general example of the recessed, not a final and completely specific design.

FIG. 13 is a right side and rear perspective elevation view in which the preferred embodiments like those of FIGS. 11 and 12 are demonstrated in use on a bus in a way similar to that in FIGS. 10A and 10B.

FIG. 14 is a left side perspective elevation view of a bicyclist as seen in the desired illuminated zone created by the invention as also illustrated in FIGS. 10A and 10B. The bicyclist is seen through a driver's side rear-view mirror between the bus' side and another vehicle's lane.

FIGS. 15 A-B are two views of a type of common vehicular LED flood lamp that is one of two referenced examples of useful, readily available and non form-specific alternative generic light sources suitable to incorporation into the lighting system invention.

FIGS. 16 A-B-C are three views of another common type of vehicular LED flood lamp that is referenced as another example of useful, readily available and non form-specific components suitable for optional use as part of the invention system.

FIG. 17 is an electrical diagram for the invention in simple form.

FIG. 18A is an enlarged side view diagram of the first listed preferred light source embodiment featuring a mechanism for adjusting lamp position and having a large glare shield. It is intended for general use as shown in FIGS. 1-4, 5A and 5B.

FIG. 18B is the bottom view diagram of FIG. 18A.

FIG. 19 is a perspective bottom view of the inner fender area of an automobile wheel well wherein a seventh preferred form-specific light source embodiment is embedded within the body with transparent lens flush to body surface.

FIG. 20 is a perspective left side and rear view of the illumination zone created by the seventh preferred light source embodiment depicted in FIG. 19.

FIG. 21A is an elevation side view of a track vehicle equipped with a variation of the seventh preferred light source embodiment mounted into the fore and aft debris shields with the illumination zones depicted.

FIG. 21B is a bottom view of the track vehicle of FIG. 21A with the two different light source lenses shown to indicate one red, and one white at each corner within this embodiment as for military use.

FIG. 22 is a perspective frontal and right side view of the sixth preferred light source embodiment used on a super transfer mining truck.

FIG. 23A is the side elevation view of the use of the seventh preferred light source embodiment which is recessed, FIG. 12, and illustrated as part of an RV body.

FIG. 23B is the top view of FIG. 23A.

### DETAILED DESCRIPTION OF THE INVENTION AND PREFERRED EMBODIMENTS

Now with regard to the description of the invention and its preferred embodiments, it is wholly the desire of the inventor to describe completely and without ambiguity, the individual components of said in the clearest and best possible terms. The invention described within this application for patent is relatively simple in design but truly indispensible to the function for which it was conceived, making it all the more enjoyable to both describe and use. In keeping with the directives set forth by the USPTO this information should enable any person with average skill in the field of this art to easily understand, make and use without lengthy experimentation.

### Symbols Within the Drawings Clarified

There are some symbols contained within the drawings that need to be clarified now. The presences of dashed lines that seem to be emitted from the light sources are intended to illustrate waves of light and a field of light onto the desired areas of illumination on the ground and within the general borders of said dashed lines. The use of the dashed lines seemed best in order to avoid clutter that would have occurred by using a thatched area for example. The views are moved to separate sheets due to the fact that the space was too limited to accommodate the numerals that accompanied each view respectively without clutter. The sheets were initially combined, having been drawn on a single sheet but were separated afterwards to make examination more efficient. All multi-view drawings are scaled the same on both views and can be viewed by placing the sheets next to one another.

### Terms “Form-Specific” and “Non Form-Specific” Clarified

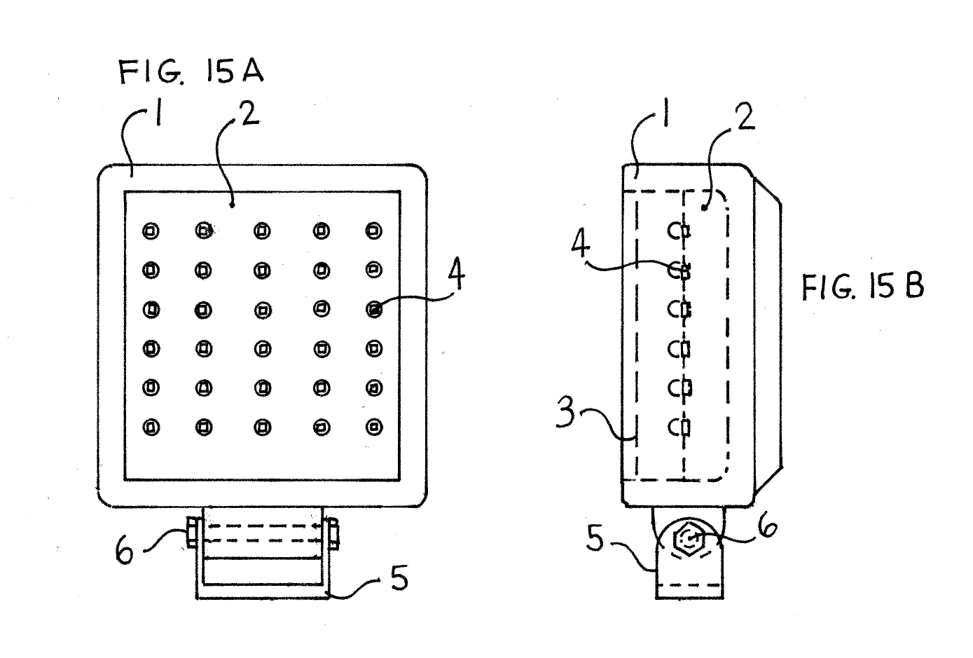

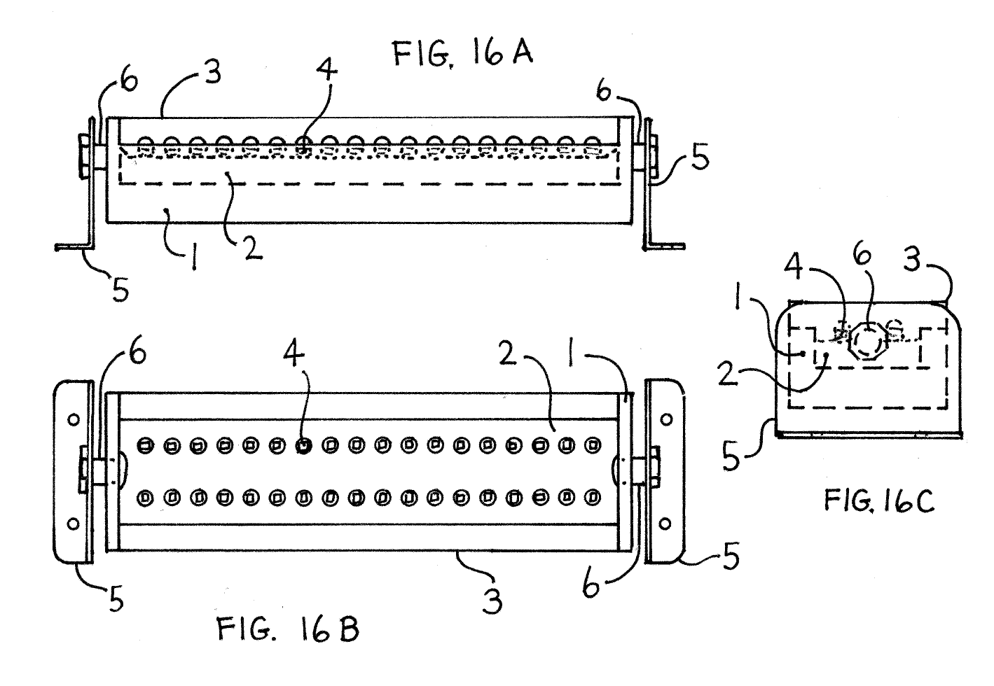

For clarification of the terms “Non Form-Specific” and “Form-Specific” that are used in the text, the terms refer to certain light source housings that may be used as components of various embodiments of the invention. Those that are purely utilitarian and common in form, not having a shape that conforms with part of a vehicle's body-specific form would be “Non Form-Specific”. On the contrary, light source housings may be molded or otherwise intentionally designed and fabricated for use on a specific vehicle body so as to become an extension of, or built into, the form and contour of the vehicle body around it. These are examples of what is considered “Form-Specific”. Any light source that is intentionally designed to fit into, or onto a specific vehicle body as part of the body, rather than be merely bolted to a bracket or bar for example, are form-specific. Some examples of non form-specific light sources are shown in FIGS. 15 and 16 A-C, where common LED flood lights for vehicular use are illustrated. They have been included as required as a reference for a full understanding of this type of embodiment or aspect of the invention's description.

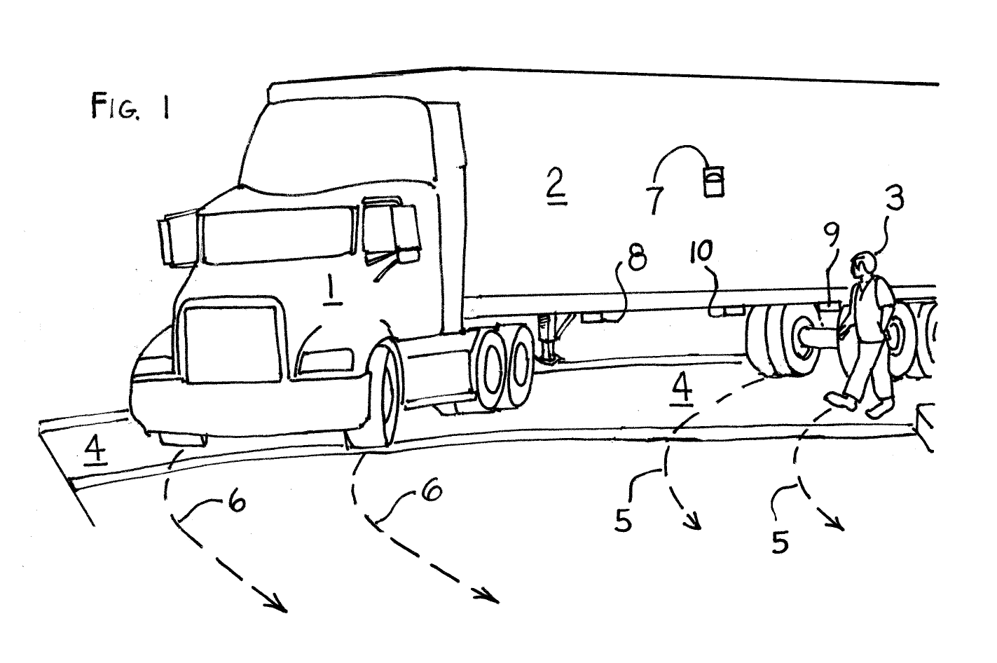

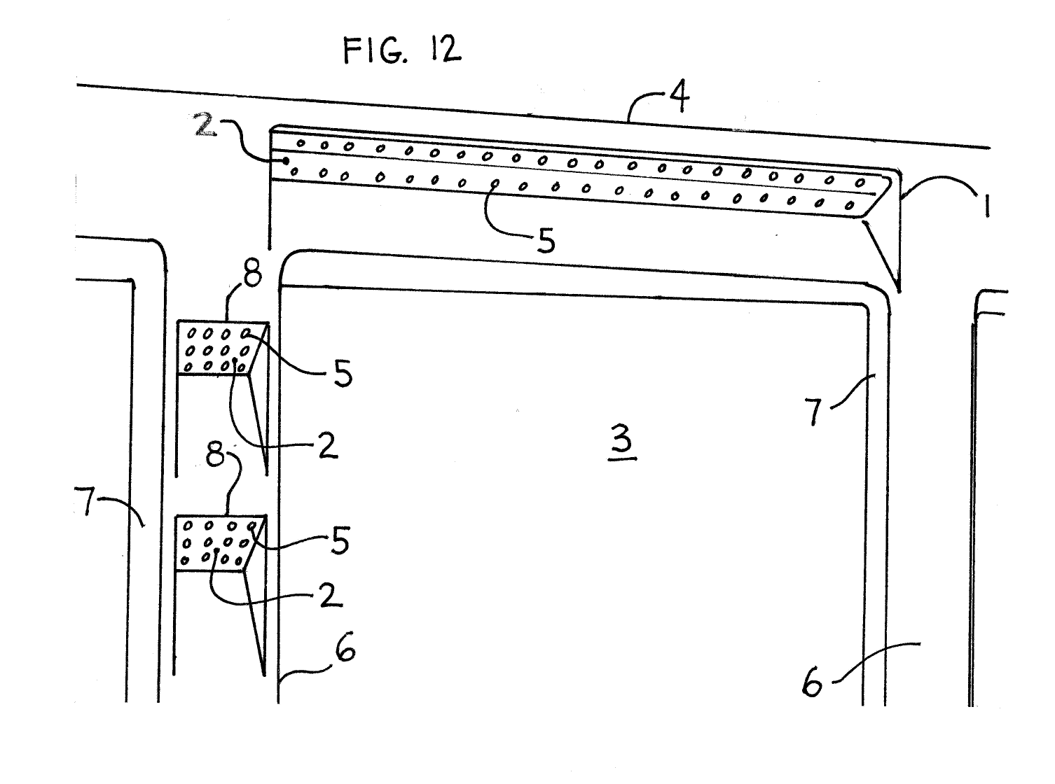

In FIG. 1 a demonstrative left side and front perspective look at a combination vehicle 1, 2 completing a left-hand turn in which it crosses over a pedestrian walkway 4 directly in the pathway of a walking pedestrian 3. The off-tracking aspect of the rear axle's pathway 5 is seen by the dashed lines in front of said axles. The tractor's front tires are clearly turning on a differing track 6 than those in the rear 5. This illustration makes clear the potential for an accident or injury when one considers this scenario is taking place in darkness. The pedestrian 3 may be caught unaware even in daytime that the rear axles pathway 5 is headed directly towards him. The idea of this occurring at night is not fiction, it happens with tragic results involving mainly combination vehicles such as this and also buses. The lighting system light sources 8,9,10 are intended to elevate safety considerably by illuminating all of the area around and below the off-tracking trailer along with the road area around and below the rear corner profile (not shown). The light source mounting locations are illustrated with 8 being the “pre-light” area, 9 is the “axle-tracking” (left side of trailer), and 10 is also in the axle-tracking position (right side of trailer). An example of a recessed light source (FIG. 12) is also illustrated as part of the trailer box wall 7. From that, or another position on the trailer box's sides, a light source can be utilized to give broader illumination if so desired.

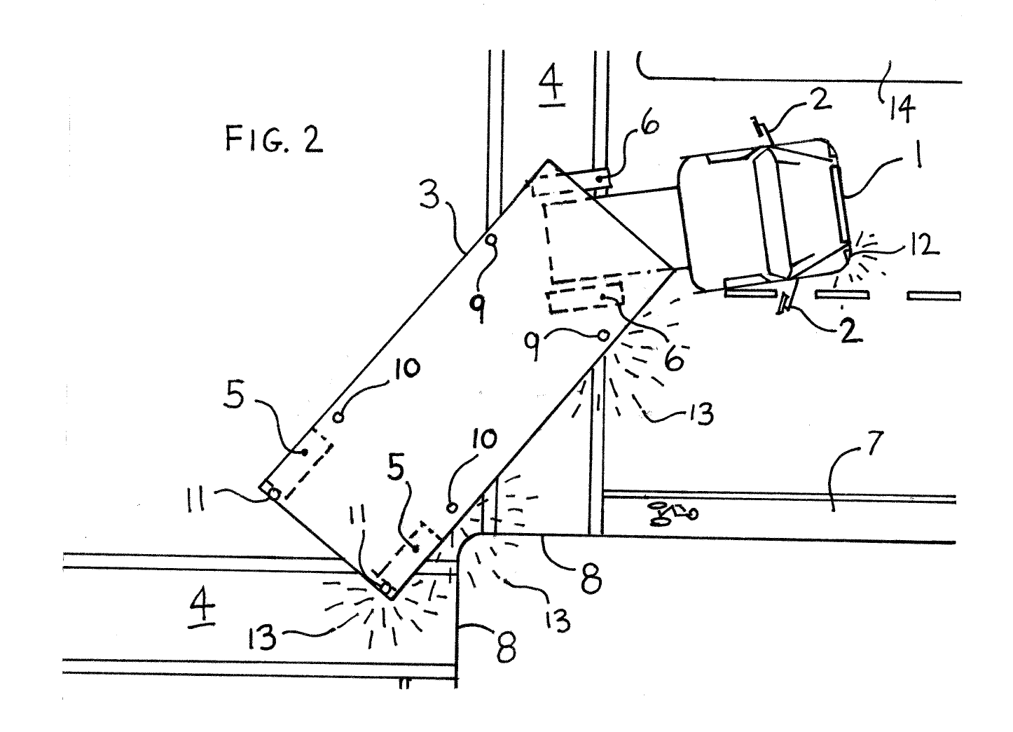

In FIG. 2 another illustration demonstrating the off-tracking of a lengthy combination vehicle 1, 3 while turning is depicted. Note how closely the rear axle tires 5 of the trailer 3 pass the edge of the curb 8 where pedestrians are often only a foot or two away. The driver relies on his mirrors 2, in this case the right mirror, by which to maneuver the trailer around the curb. The lighting system locations are seen here at 9, 10 and 11. Each light source location is numbered the same for each side. 9 is in the pre-light position, 10 in the axle-tracking position and 11 is located at the rear profile position. The light waves are illustrated as dashed lines that originate from the light sources and extend generally to the edge of the dashed lines 13. The dashed lines depicted indicate a light radius of at least a five to seven foot radius of well lit area, a safety zone, with the light sources directed essentially downward. The bike lane 7 is also illuminated as the vehicle turns, along with the crosswalk 4. The dashed lines at the front right corner of the tractor are originating from the turn signal 12 to indicate that the lighting system has been actuated by a controller in conjunction with use of the turn signal switch. The rear wheels of the tractor 6 are seen also along with the concrete center divider 14.

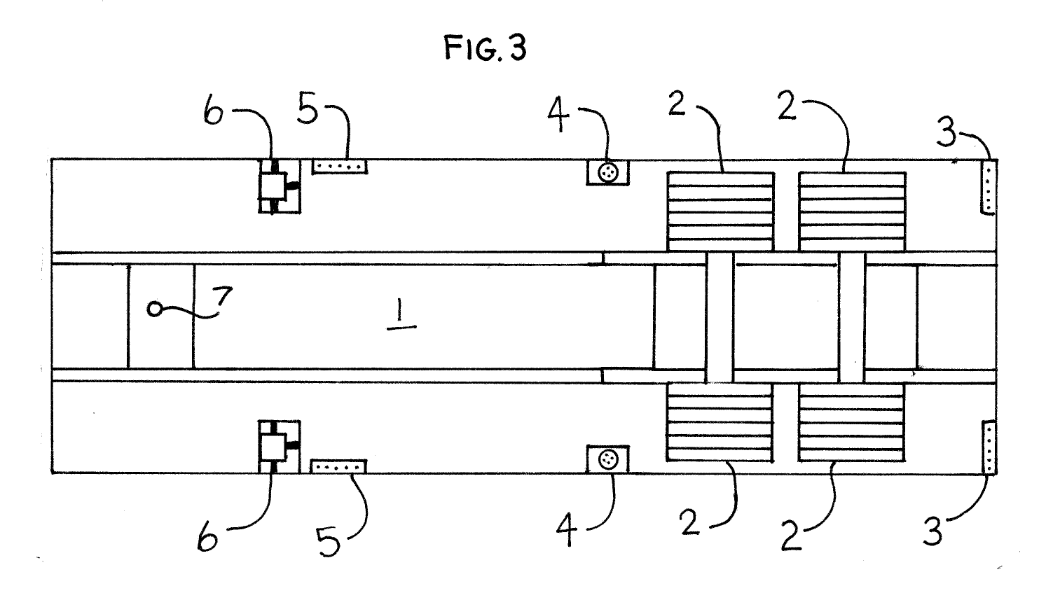

The illustration of FIG. 3 is a bottom view layout of the general preferred mounting locations on a commercial trailer for the lighting system light sources. The trailer 1 has six individual locations depicted within three separate areas. The first area from front to rear is the pre-light position 5 which consist of two rectangular light sources mounted on each side of the trailer equally, in the proximity of the trailer landing gear 6. Next are the axle-tracking light sources 4, mounted on both sides at a position that illuminates the exact position and pathway of the trailing axles 2 for the driver. Lastly, the rear edge profile light sources 3 are shown as rectangular and mounted along the rear edge and underside of the trailer. The trailer kingpin is located toward the front of the trailer 7. All light sources shown are not specific as to type or form but rather are indicating some crucial preferred locations that optimize the use of the lighting system.

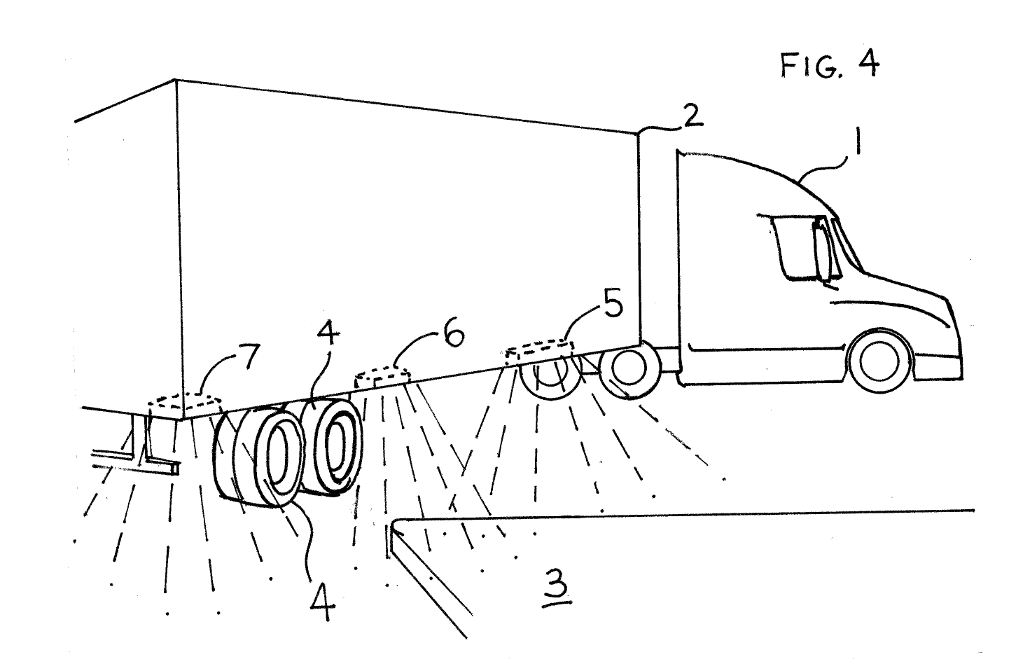

To further demonstrate off-tracking from another viewpoint, the FIG. 4 right side rear perspective view of a combination commercial truck and trailer, 1 and 2, turning right and rounding the curb 3 demonstrates the general field of illumination and how it assists the pedestrian and driver by creating a heightened safety zone providing warning and illumination in darkness to the position and pathway of the turning vehicles. The pre-light area light source 5 is seen along with the axle tracking area light source 6. The axles themselves are next 4, with the rear edge profile light sources 7, seen last. Note that no specified type of light sources are intended, rather the overall illustration of combination vehicles off-tracking as seen at street level is depicted.

NOTE: The following FIGS: 5A, 5B, 6A, 6B, 7A, 7B, 8A, 8B, 9A and 9B are all depictions of preferred embodiments in use on the rear portions of commercial trailers. As mentioned, these paired drawings were done together and are of equal scale and should be viewed one above the other. Each of the “A” FIGS, depict only the left half of the rear trailer area, shown as an elevation drawing. The “B” FIGS depict the under-side view of the same. It is to be assumed that both sides of the trailer are of course identical and would have the same lighting system light sources on each side.

To avoid clutter and redundancy, the “pre-light” area components of the lighting system are deliberately left out of these drawings due to having the same components (or combination thereof) as those shown in the axle-tracking or rear edge profile position. Wiring is not always included in each drawing but it should be understood that wiring methods common to this application are used where needed except of course for a wireless method. Also, in some cases the field of illumination as indicated by dashed lines is somewhat incomplete in an effort to avoid clutter and/or exceed the drawing margins. All the illustrations themselves are intended to express a clear approach and “fleshing out” in regard to embodiment as to achieve the purposes of this invention, illumination zones for control and safety, as is exhaustively set forth herein, but should not be viewed so narrowly as if the illustrations defined in totally exact terms, the ultimate end design, shape, and precise location etc., as such variables are indeed too numerous to communicate.

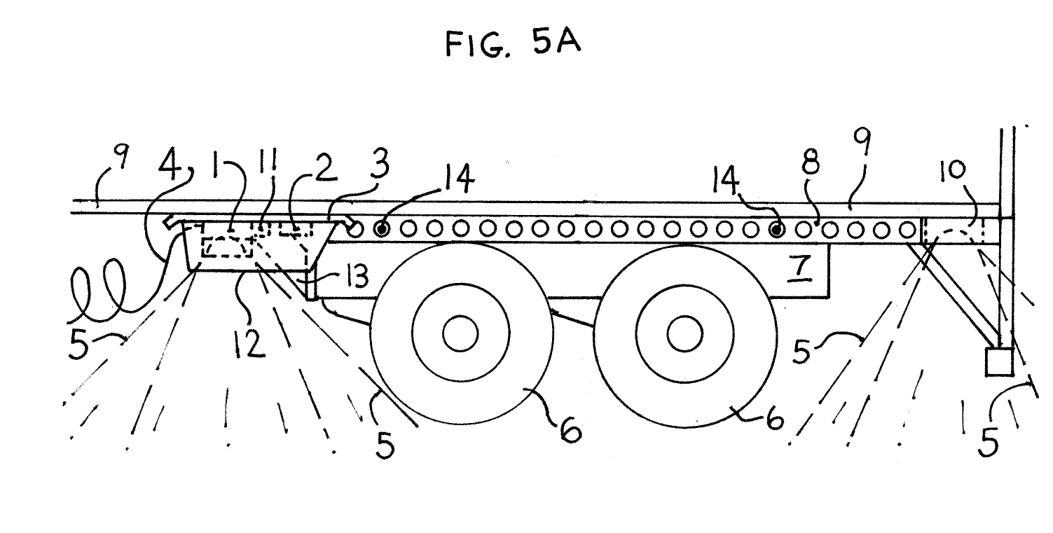

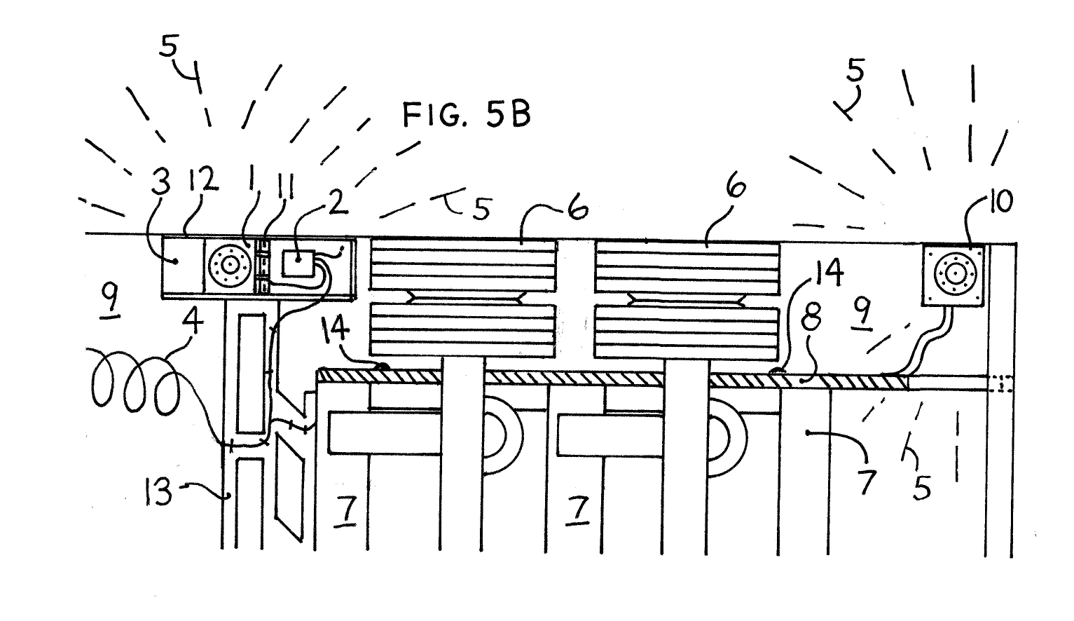

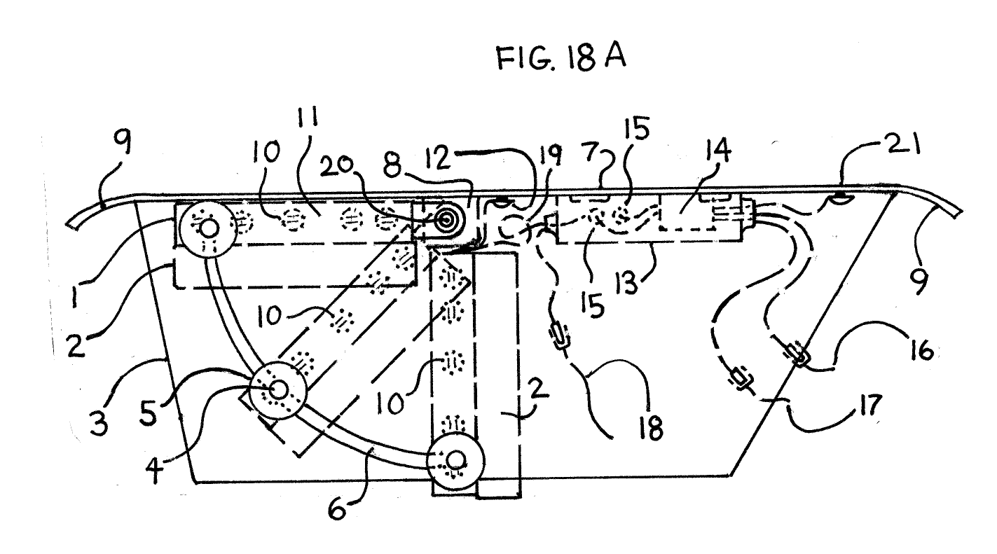

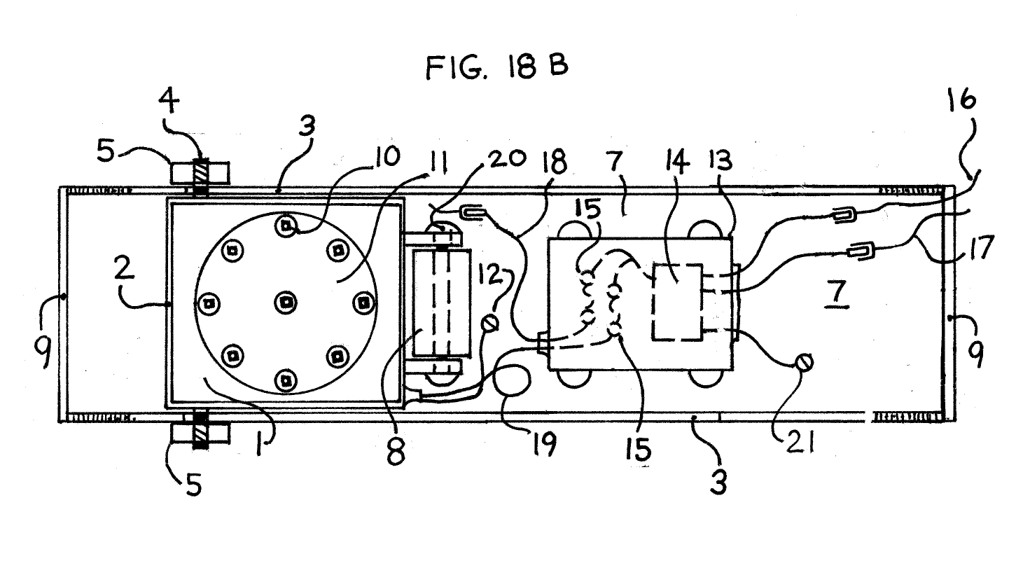

In FIGS. 5A and 5B a first preferred embodiment of the lighting system is illustrated (for enlarged illustration see FIGS. 18A-B) in which a partial left side view of a commercial trailer at the rear axle carriage area 7, below the trailer floor 9 is depicted. The first system light source 1, mounted at the “axle tracking” position, consists of a common, non form-specific 12 v DC LED flood light (of the type in FIGS. 15A-B and 16A-C) with a luminous flux of preferably 1500 lumens or more of an extreme duty class being shock resistant and weatherproof and is mounted with its lens downward and housing horizontal to a mounting component plate 3 by means of a durable hinge style mounting mechanism 11 attached to the light source housing. The hinge style component allows for adjustment of the floodlight from a 180° straight downward to 90° rearwards, towards the trailer wheels, 6. The structural plate 3 that is in contact with the floor 9 of the trailer is preferably made of a corrosion-resistant metal alloy or durable polymeric material that has two equal sides 12 of the same, or different suitable material that serves both as glare shields and as a structural reinforcement that allows for the light source face to be adjusted as stated in order to direct light downward and rearward as needed to focus light field 5 toward the trailer wheels 6 when they are repositioned by means of the sliding of the axle carriage 7, along the axle carriage rails 8 (shown thatched in FIG. 5B) that have holes by which to accommodate the axle carriage pins 14. Said axle carriage pins 14, fix the axle carriage in place once adjusted. The light source housing 1 and mounting structure 3 and 12 are themselves fixed onto a durable reinforced bracket 13 of sufficient strength and is itself fastened to the axle carriage 7. This allows the lighting system components to travel with the axle carriage 7 when it is repositioned along the axle carriage rails 8. Alternatively, the lighting system mounting structure 3, 12 with all components may be fastened to the underside of the trailer floor 9 at an advance position in front of the axle carriage 7 and rails 8, and NOT be connected to the sliding axle carriage by means of the bracket 13. Then in this configuration, only the light source housing 1 itself tilts to the desired position but the mounting structure 3, 12 is immobile while the axle carriage 7 slides. The light sources 1, 10 are actuated by the externally located controller 2 (when not actuated by the dedicated independent switch). Said controller is located within a weather resistant box itself also externally mounted to the mounting structure plate 3, having sides 12 and reinforced bracket 13. The second light shown, at the “rear-edge profile” position 10 is a similar light with a brightness rating of preferably 1500 lumens or more and is fixed by a mounting mechanism or hardware directly to the floor supports or framework of the trailer with its lens facing down 180° and its field of illumination is down and outward peripheral 5. The wiring harness 4 is comprised of a weather resistant flexible sleeve or sheath wherein a sufficient length of wiring is coiled and suspended from the trailer floor by a spring (not shown) allowing for expansion and contraction as needed when the axle carriage 7 is repositioned. Said sheath is also attached to the reinforced bracket 13 that supports the lighting system components.

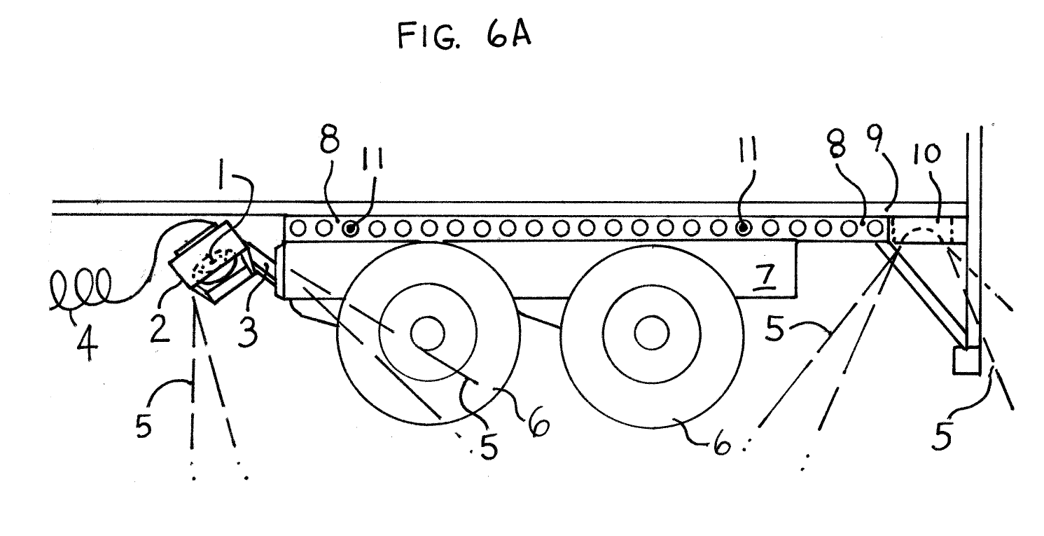

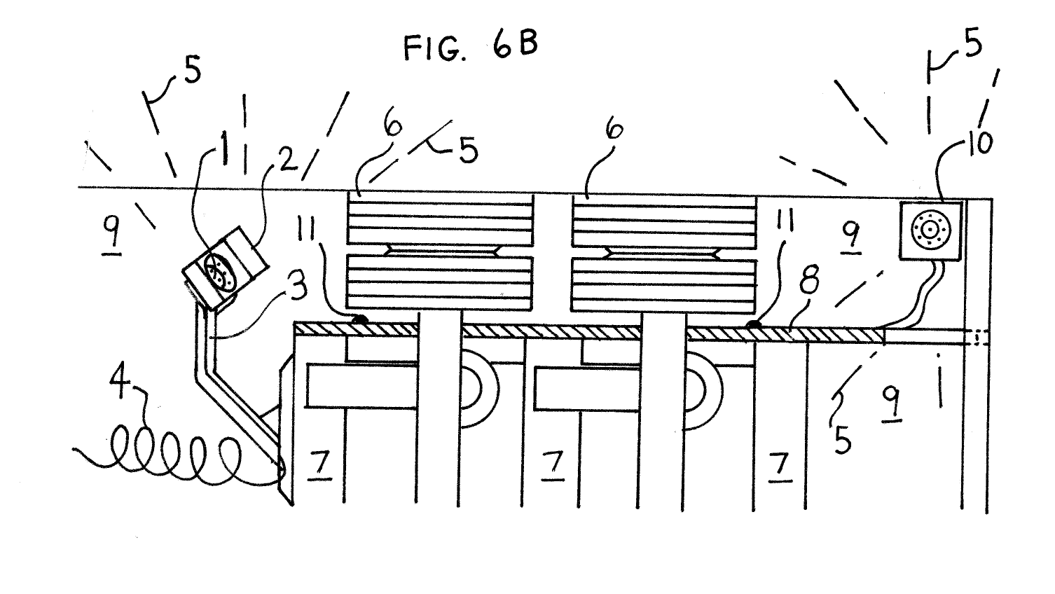

In FIGS. 6A and 6B, a second preferred embodiment of the lighting system is illustrated in which a partial left side view of a commercial trailer at the rear axle carriage area 7 below the trailer floor 9 is depicted. Said lighting system has non form-specific 12 v DC LED flood lamps, 1 and 10, of an extreme duty class being shock resistant and weatherproof with a preferred luminous flux rating of preferably 1500 or more and housed in a thermally conductive material such as an aluminum alloy. The flood light in the “axle tracking position 1 is fitted with a thin glare-shield 2 that is affixed to the light source housing at the perimeter of its body around the lens face extending to a sufficient length of roughly 3 to 5 inches. Said light source is mounted to the sliding axle carriage in a fixed position by means of a durable bracket 3. The bracket is designed to accommodate the light source 1 by means of mounting hardware, bolts or other sufficiently strong method. Said bracket, 3 itself having a predetermined shape and angle is attached to the sliding axle carriage 7 that enables the illumination 5 to project from a roughly 45° angle, or an angle that best optimizes illumination to the “axle tracking” area from the fixed light source 1 in such a way as to provide optimal illumination 5 to the exact position and pathway of the trailing axle wheels 6. In contrast to the first embodiment (FIGS. 5A-B) which tilts, the bracket 3 and flood light 1 are not in contact with the floor 9 of the commercial trailer. The axle carriage 7 slides along the axle carriage rails 8 (having diagonal lines) allowing the driver to reposition the axles for desired weight distribution. The axle carriage locking pins 11 ensure that the axle carriage is held in the desired position. The light source 1 held by the bracket 3 is able to travel with the sliding axle carriage 7 and always maintain the desired optimum angle and field of illumination 5 necessary to perform at the location referred to as “axle tracking position”. The wiring harness 4 is in a weather resistant wire sleeve sheath that is coiled and suspended from the trailer floor allowing for expansion and contraction as needed when the axle carriage 7 is repositioned. It is also attached to the reinforced bracket 3 that supports the lighting system components. The second light shown, the “rear-edge profile” light source 10, has a brightness rating of preferably 1500 lumens or more and is also fixed by a bolted mounting mechanism or hardware directly to the framework of the trailer or floor supports. Said rear light 10 is electrically connected by suitable durable corrosion resistant wiring as are all lighting system components and light sources regardless of the embodiment. The field of illumination 5 of the rear edge profile light 10 is down and outward peripheral and the light source shown is preferably fixed in position but can alternatively by fitted with mounting hardware that enables tilting.

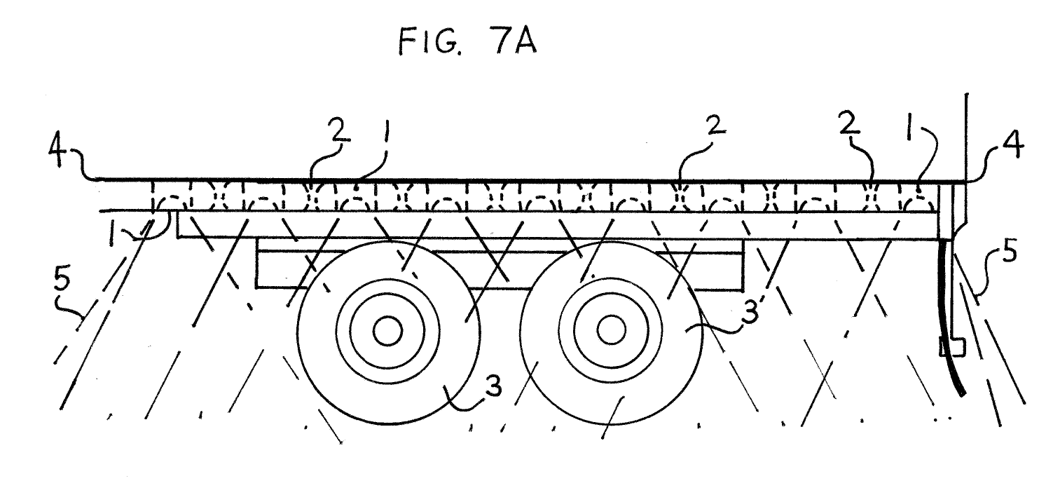

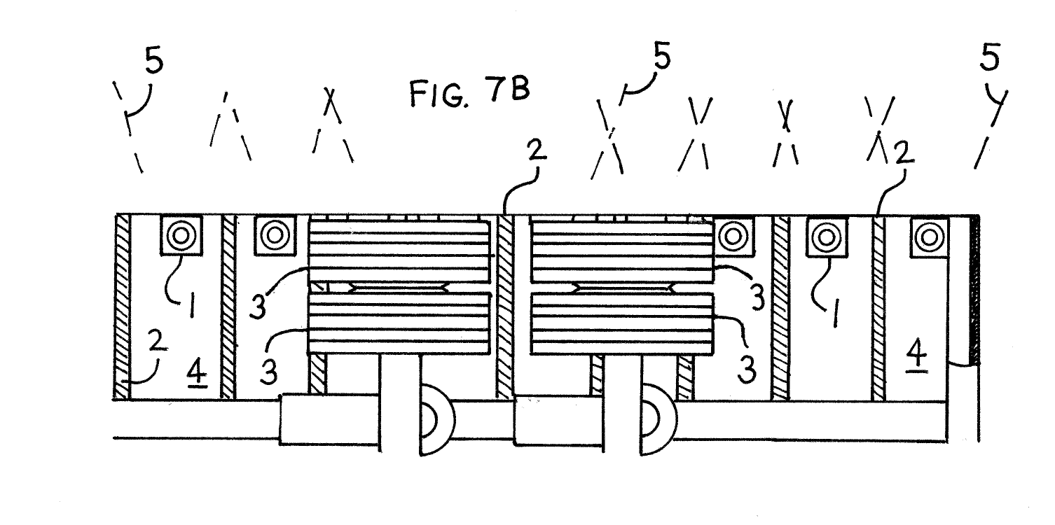

In the illustrations of FIGS. 7A and 7B a third preferred embodiment of the lighting system having no moving parts, but being made up of a pre-determined quantity of continuously arrayed individual, durable and weather resistant 12 v DC LED flood light sources 1 is depicted. Said light sources are of an extreme duty class being shock resistant, weatherproof, and mounted on or between the floor supports 2 (shown with diagonal lines in FIG. 7B), below the trailer floor 4 of a commercial trailer. Said light source housings 1 are non form-specific as to shape but require varied specialized mounting components that are size-specific to the individual framework on a given vehicle. These LED light sources preferably have a brightness rating of at least 500 lumens or more per unit and is free of the moving parts and position adjustment components that are part of some other preferred embodiments of the lighting system. The light sources 1 are placed in the spaces between the floor supports 2 and may continue for the length of the distance between the “pre-light” zone near the landing gear of the trailer, through the “axle-tracking” light position area and ending at the “rear-edge profile” position (refer to FIGS. 1-4). The placing of light sources 1 between floor supports 2 can vary to some degree because more luminous light sources would have a sufficiently strong field of illumination 5 that could adequately illuminate the road area that spanned the length of say four floor supports, because of variables like lumen strength etc. This embodiment's approach is for the purpose of creating a total continuous field of illumination without the need for adjustment of any kind, and is sufficient regardless of trailer axle position adjustment (the axles are non-adjustable in this depiction) for the entire underside area has had light sources installed. This version of the lighting system is actuated in like manner and methods as are other embodiments described.

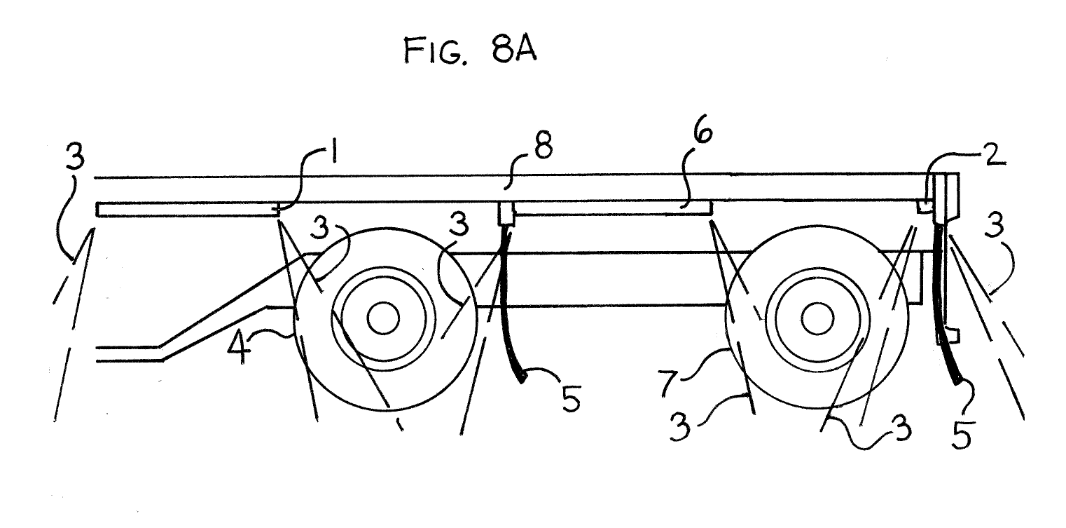

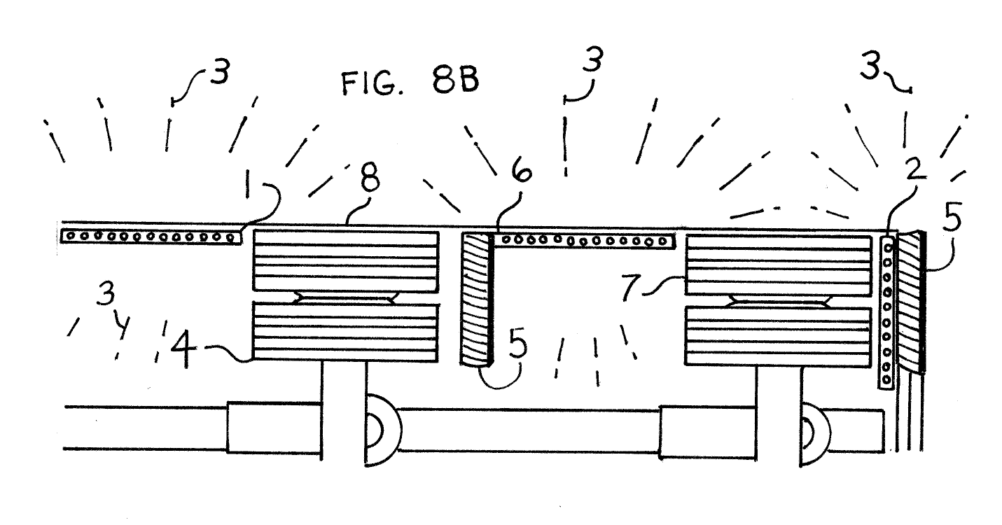

The illustrations of FIGS. 8A and 8B are the side elevation and bottom views of a fourth preferred embodiment of the lighting system that also has no moving parts. This embodiment of the lighting system is depicted in use on a commercial spread axle flatbed trailer. This preferred embodiment is suitable for use on several vehicle applications due to its illumination strength and simplicity. It is made up of strip-style 12V DC LED flood lamps 1, 6 and 2 that are of an extreme duty class being shock resistant and weatherproof and mounted to the underside at or near the edge of the trailer deck 8 in specific desired locations by means of bolted mounting components. These light sources measure roughly 2.5″×4′ and are generally non form-specific as a rule and are similar to those in FIGS. 16 A-C. Of course the length of this style of LED bar 1, 6, 2, can be manufactured to a preferred width and length. These particular light sources because of their size and quantity of LEDS can have substantially greater brightness as measured in lumens and could be upwards of 2 to 4,000 or more. Depending on the use this may or may not be ideal, although for this use, a lumen rating of preferably 1500 or more each should be used. The light sources mounted at the “axle-tracking” positions 1, 6 are providing a field of illumination 3 in front of the first and second axles 4, 7, wherein a lengthy advance lighting effect upon the ground surface ranging from seven to ten feet is desirable in addition to that from the light source in the “pre-light” location (not shown). The light source 6 shown in front of the last axle 7 serves as a 2^{nd} axle-tracking area illuminator. This is highly desirable because of the greater difficulty encountered in maneuvering a split-axle trailer over others. At the rear the final light source 2 having a brightness rating of at preferably 1500 lumens or more, is itself mounted at the “rear edge profile” location. The illumination field 3 of this final light source extends outward from the sides and rear to a distance of five to seven feet or more making visible the rear profile of the trailer in the driver's rear view mirrors as do the other embodiments. Mud-flaps 5 are also shown mounted behind each axle's tires.

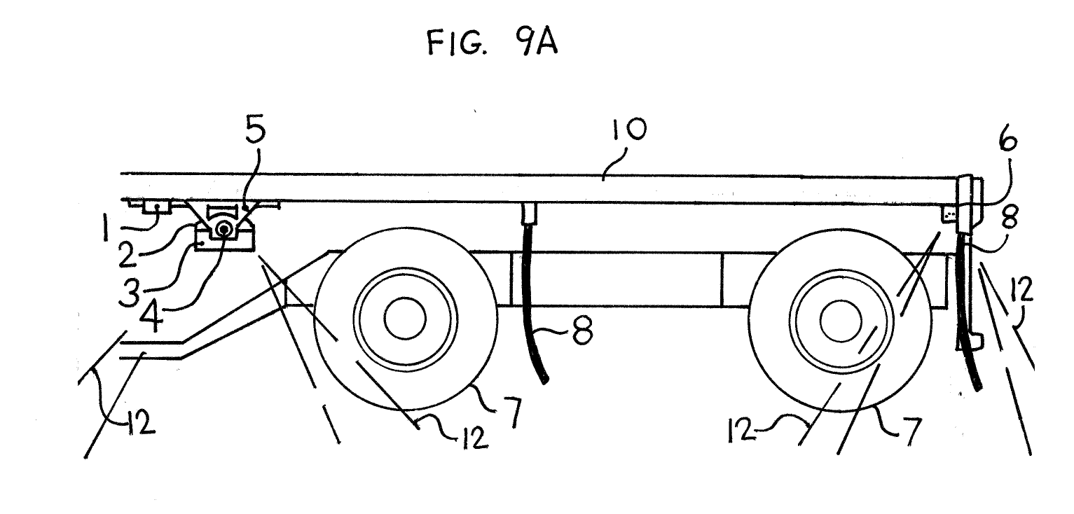

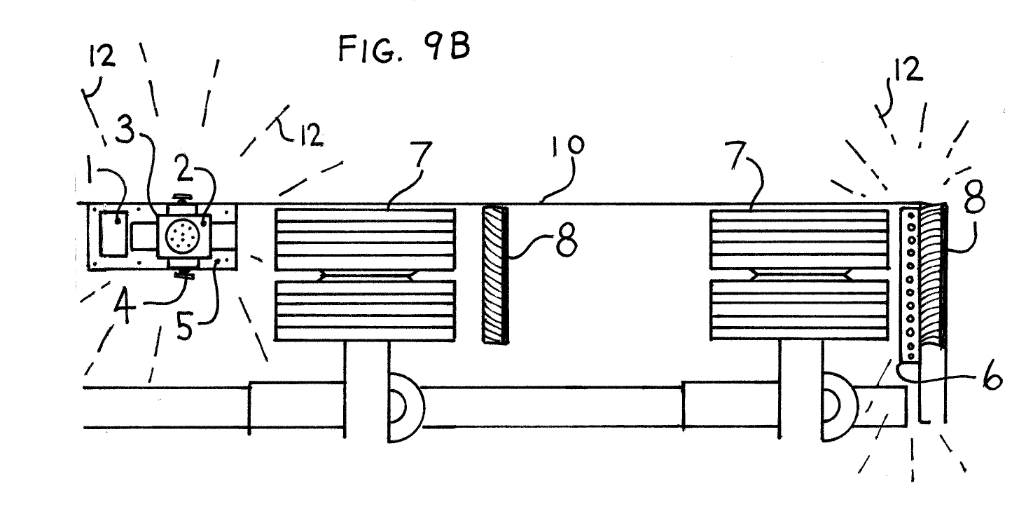

In FIGS. 9A and 9B an illustration of a fifth alternative embodiment of the lighting system is depicted for use in this illustration on a split axle commercial trailer. The two light sources 2 and 6 are duplicated on the unseen side of the trailer. As mentioned, the light sources of the “pre-light area” near the trailer landing gear are not shown to avoid redundancy. All light sources are 12V DC LED flood lights of an extreme duty class, shock resistant and weather proof. The first, 2, is larger in size, preferably six inches in lens diameter, with a brightness rating of at least 1500 lumens or more. Said is equipped with a reinforced mounting component built into the housing 2 that consists of two studs that extend outward from the reinforced housing and fit into the durable mounting component 5 which is made of a corrosion resistant metal alloy or polymeric material. Said studs are fitted with simple tightening wheel-nuts 4 (not shown in detail) that thread onto the stud at each side of the housing. This simple method allows for rapid adjustment of position by loosening the wheel-nuts on each side of the housing 2, adjusting the light to the desired position from 90° rearward to 270° forward facing) and re-tightening the wheel-nut 4. A locking feature is disposed on the nut similar to that on the front wheel hubs of touring bicycles whereby the wheel can be quickly removed and remounted and well tightened. The wheel-nuts do not loosen but maintain the light source 2 in its position. A thin metal glare shield 3 is a component of the housing at its outer edge around the lens, extending from say three or more inches. Also a lighting system controller is located within a weatherproof likely polymeric box 1 that is itself attached to the light source mounting component 5 that is bolted to the underside of the trailer deck at or near its edge 10. The light source 2 in the “axle-tracking” position creates a field of illumination 12 that is preferably from five or more feet in radius when in the 180° (from vertical) position. This becomes a sizable flood of light in either direction fore or aft when adjusted thus. The light source at the “rear-edge profile” position 6 is “bar style” unit with a brightness rating that is preferably 1500 lumens or more and is mounted in a standard way with mounting hardware to the underside of the rear edge below the trailer floor 10, and in proximity to the rear mud-flaps 8. As with all embodiments, the illumination 12 from said, as seen in the rear-view mirrors, needs to be sufficiently bright to clearly identify all desired parts of the trailer, surrounding objects and the road surface proximate in darkness. The peripheral field of illumination from all light sources onto the road surface should preferably be from five or more feet in radius each.

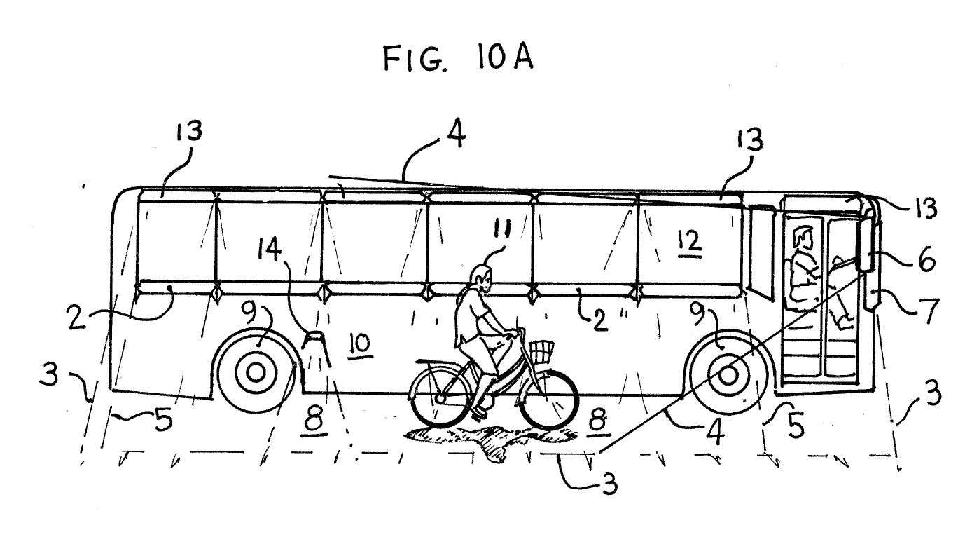

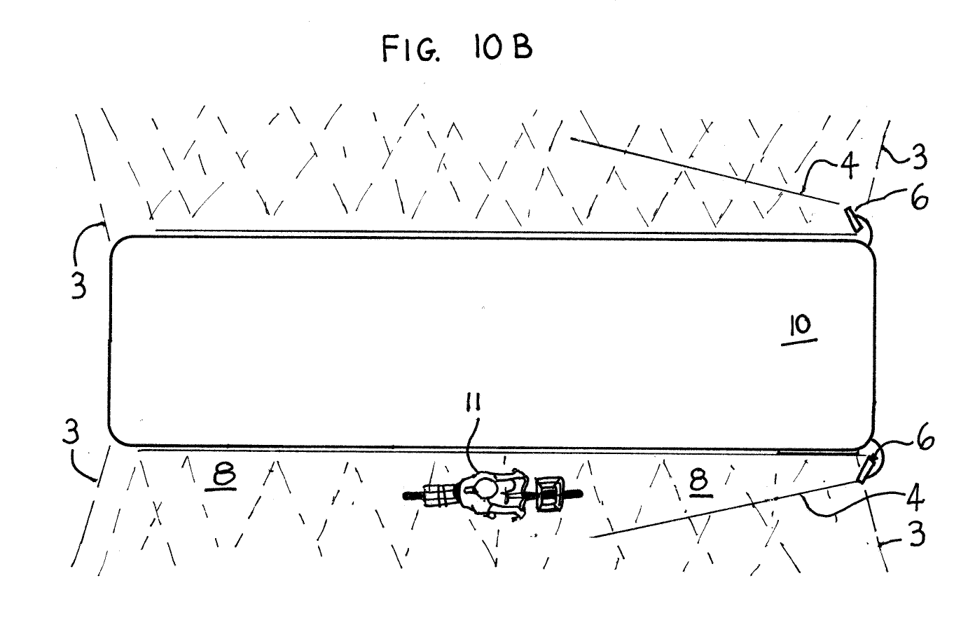

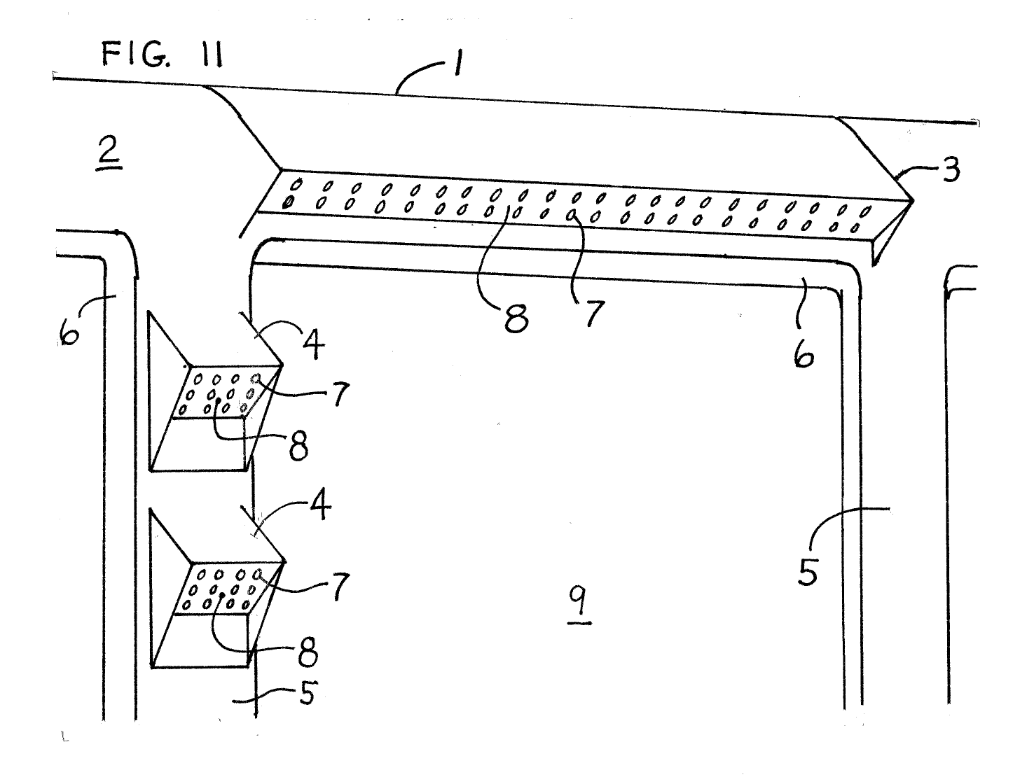

In FIGS. 10A and 10B another preferred embodiment having form-specific light sources 13, 14, and 2 is illustrated for use on a bus vehicle. The right side elevation view and top view of the bus 10 with a bicyclist 11 is demonstrating two viewpoints of the practical usefulness gained from the employment of the lighting system. In the side elevation view of FIG. 10A, a series of individual bar style recessed or protruding light sources 13 are seen as part of the bus' body sides all along the topmost portion of the window frame area 12. Another suitable location for light sources is along the lower portion of the window frame 2. The illumination from both cover the full range of ground surface 8 and wheel position and pathway area 9, thus creating a well-lit safety zone. The two locations where this embodiment is located 13, 2 may be used simultaneously or separately, either at one or both locations, although the upper 13 is a position that likely delivers a broader field of illumination 3. The lower series of light sources 2 although providing a slightly less broad ground pattern perhaps, are likely to deliver a more-dense and brighter field of illumination, 5 than that from above, 3. The light sources depicted are similar to those illustrated in FIGS. 11 and 12 wherein light sources are shown as built into or part of the contour of the bus body. The LED light sources shown are of an extreme duty class, shock resistant and weather proof consisting of internal components common to this grade of vehicular LED flood lighting as would be the case for all embodiments in their respective application. In both FIGS. 11 and 12 the roof support posts between window openings have light source housings either recessed within them or protruding from the surface. The illustrations of FIGS. 10A and 10B do not include light sources installed as part of the bus' roof support posts. The bus illustration does feature the use of a form-specific light source 14 in the “axle-tracking” position for use in illuminating the position and pathway of the rear axle. It is also generally similar to those examples given in FIGS. 11, 12, 23A and 23B. The field of illumination from said light source as indicated by the dashed lines toward the ground 8 is not individually identified due to being self evident. The fields of illumination created by the upper light sources 13 is indicated by the dashed lines 3 that begin at the one end of the bus, above the entry door, and extend to the rear of the bus. A full field of illumination onto to road surfaces 8 is indicated all along each side of the bus and extends to a desired peripheral radius of preferably five or more feet outward from the bus' sides. In this way all road surfaces 8 and objects, vehicles, curbs and most importantly persons proximate 11, are illuminated within this critical area. The driver's range of rear view through the use of the side mounted rear-view mirrors 6 is illustrated by the solid lines 4 extending from the mirrors. The lighting system, as in other on-highway embodiments, is actuated as described in the Brief Summary of the Invention. The city bus may best be served by continuous illumination of the lighting system as activated by a photocell photoelectric switch whereas the touring coach in contrast, may likely utilize the system more the way the tractor-trailer would, with fewer side mounted light sources 13, 2, 14, than does the city bus because of the brief time spent within city traffic. Hence differing large passenger buses may be fitted with a variety of embodiments and control methods other than what is put forth here, as so desired by the user.

In FIG. 11, the illustration features a partial view of a vehicle side, like that of a bus with a main window opening 9, window frames or molding 6, roof supports or posts 5 and a roofline 1. The light sources 3, 4 are basic examples of protruding light source housings that are form-specific and for integration onto or into the body surface as those depicted in FIGS. 10A and 10B. These LED light sources 3, 4 are as set forth in the claims and otherwise are described as being of an extreme duty class, shock resistant and weather proof consisting of internal components common to this high grade of vehicular LED flood lighting. The upper “bar style” LED light source 3 is protruding from the mostly flat surface of the bus body 2. Said light source is fitted with a plethora of LEDS 7 set within a highly reflective material 8 and having a durable translucent lens of glass, acrylic, polycarbonate or other suitable material (lens is deliberately not included to avoid clutter). The other two duplicate LED light sources 4, are disposed at points along the exterior surface the roof posts 5. They also have LEDS 7 mounted within a highly reflective material 8 with a light source housing 4 also having a translucent lens (not shown). The angle of the faces of the light sources are not specific as to a particular degree of angle in relation to vertical or horizontal, it is only a depiction of the general form of a preferred embodiment. Specific design details such as dimensions, contours etc., as with all form-specific embodiments are dependent upon specific applications to a particular vehicle. A number of types of vehicles that would be an excellent fit for this or the recessed variety of light sources (FIG. 12), as applied to the purpose and function of this invention are buses, straight trucks, tractor and trailers, RV trailers, utility trailers, and of course automobiles etc. to name a few, wherein the light source housings can effectively be integrated into the body at a location like those described or specifically suitable in order to provide a safety zone by the field of light onto the road surface for the benefit of the driver and persons proximate.

Illustrated in FIG. 12 is an alternative recessed version of the form specific light sources illustrated in FIG. 11. The internal components and high grade of quality and durability of said is the same as what is optimal in the industry as are all preferred embodiments of the lighting system herein. The light source housing 1 is recessed and embedded into the body at a point above the window 3, and below the roof line 4. The other two LED light source housings 8 are of the same characteristics and are located at points within the roof support posts 6, on either side of the window 3 with its molding 7. Instead of being a lengthy bar style light source like that 1 above the window 3, the lights built into the posts are smaller and are configured over and under. The quantity could exceed the two shown here and could be used exclusively or in conjunction with the light source 1 above the window 3. Each LED light source shown has the same basic components illustrated such as a reflective material 2 having mounted within it at least one or more LEDS 5 but the lens is not illustrated to avoid clutter. The upper light source 1 is the more optimal in that the linear field of light is near totally unbroken when mounted end to end in series as shown in FIGS. 10A, 10B, 13 and 14.

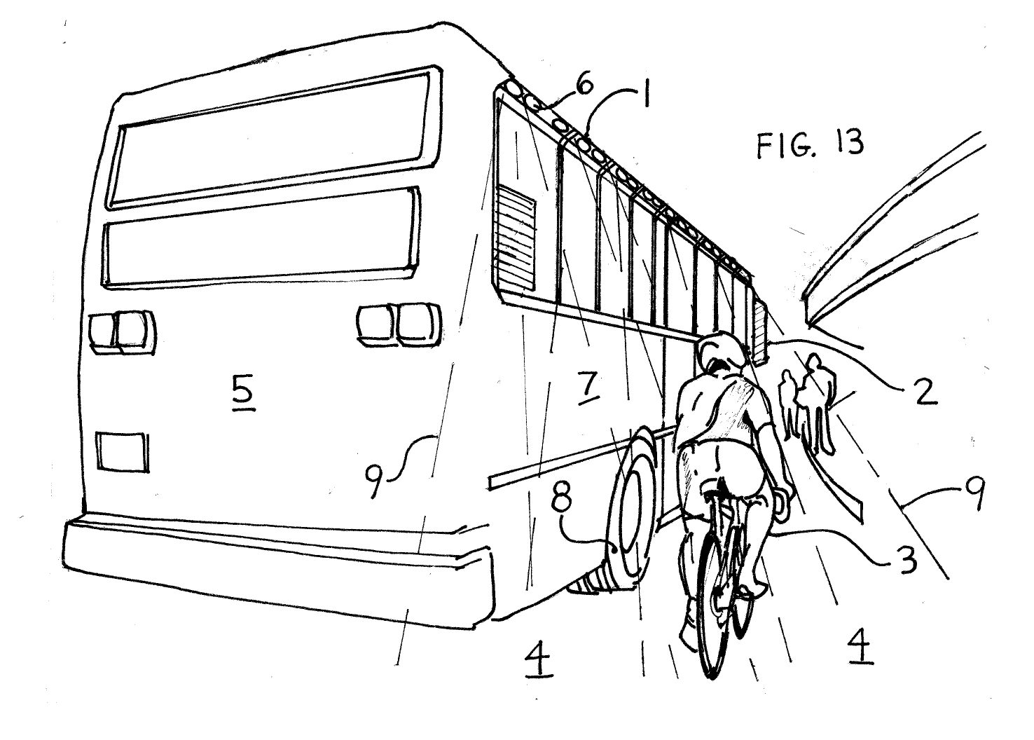

The illustration of FIG. 13 is another demonstrative example of a preferred embodiment of the lighting system in use on a bus in common city traffic. The bus' right side 7 and rear portion 5 are visible, as well as the roofline 1, right rear axle tires 8 and ground surface 4. In the illustration a bicyclist 3 is pedaling alongside the right side of the bus 7 and the rearmost part which is the most difficult to visually pick up by the driver who does so via the use of the right side mounted rear-view mirror 2. Although the illustration background is essentially all white it is to be viewed as if all was darkness besides the field of illumination 9 depicted by the presence of dashed lines emanating from the light sources 6 built into the upper side 7 just above the windows. A slightly protruding overhang from the roof 1 is visible wherein said light sources 6 are built into underneath. Said light sources are illuminated and the faces of said are in a position of a predetermined angle that enables the desired flood of light to the desired area 4 and the resulting field of light should be at least a five to seven feet or more radius out from the vehicle sides. Within said illumination field 9 the bicyclist 3 is illuminated along with the road surface proximate 4 both behind and in front also because the light sources extend to the very front of the bus' upper right side thereby illuminating all the area, starting at the bus' entrance door and extending to the rear end of the vehicle. In this manner the position and pathway of the vehicles rear wheels 8 is easily identifiable in the rear-view mirrors 2. The left side of the bus is not visible in this view but the intention is that the same light sources 6 of the lighting system are in use as needed there as well. The light sources 6 could be adjusted individually by means of a tilting mechanism, FIGS. 15 and 16 A-C#6, if so desired and could also be individually controlled or actuated if so desired in keeping with the purpose of having a well lit safety zone created by the completely new field of light from the lighting system.

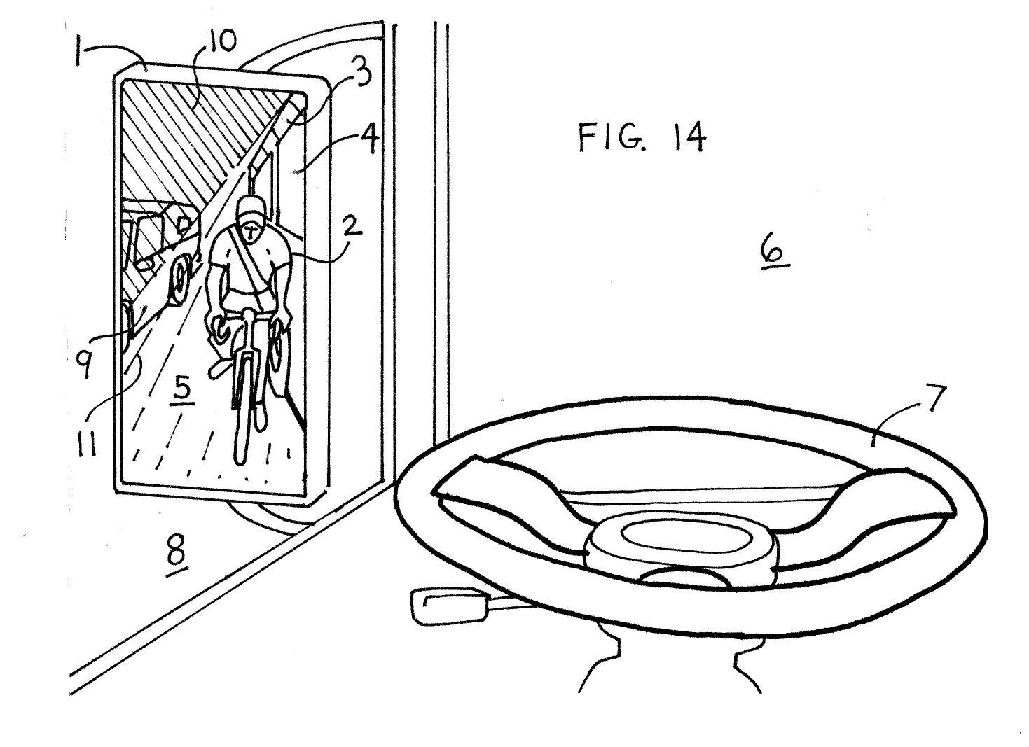

In FIG. 14, an illustration from a left side perspective view of a bicyclist 2 is in the desired illumination zone 11, as seen from a bus driver's viewpoint through the left side mounted rear-view mirror 1. The entire background outside the vehicle is intended to imply darkness although to avoid clutter, only the view area in the mirror has a shaded portion 10 contrasting the field of illumination 11 onto road surface 5. The left rear side of the bus and its windows 4 next to the bicyclist 2 and the road surface 5 is clearly visible in the illumination field 11 that is generated from the light sources 3 positioned along the body of the vehicle at a point above the windows 4. By this means the position and pathway of the bus' rear wheels and sides are illuminated for the benefit of both the driver and the cyclist. The shaded area 10 is indicating the darkness outside the field of illumination wherein a vehicle 9 travelling alongside the bus is also visible. This of course is an added benefit, that the traffic proximate should be partially illuminated in the peripheral field of illumination. As seen in the mirror 1, both the vehicle and bicyclist comprise an alternative situation and viewpoint than that, but similar to, what is depicted in FIGS. 10A, 10B and 13, wherein a bicyclist is illuminated in various locations inside the field of illumination created by the lighting system light sources along the other side of the vehicle. The other items numbered in the illustration are the left side driver area window 8, the steering wheel 7 and front windshield 6. The situation in FIG. 14 can come about when a bus or other vehicle is travelling so slowly that the bicyclist attempts to pass between lanes, or the vehicle may be stopped by the curb while loading passengers prompting a pass by the rider. Either way, in darkness without the lighting system, the passing cyclist is invisible and susceptible to being struck by the vehicle as it pulls back into traffic. This is in large part similar to the circumstance responsible for the occasion of accidents with bicyclists.

In FIGS. 15 and 16 A-C, commonly available LED flood lights for vehicles are depicted as examples of what may be utilized in some non form-specific embodiments of the lighting system as a whole if so desired by the user. They could even potentially be integrated into a body as a component that is only partially form-specific. In fact, the illustrated lights don't begin to represent the totality of unit styles available but just give a sample of good candidates. The potential use of common “off the shelf” LED flood lamps for some applications is not meant to limit or define the invention in any way but rather to broaden it. The lighting system is embodied and expressed in many ways from utilitarian non form-specific, to highly integrated and form-specific. The invention is less defined by what type of LED light source is utilized but rather the totality of the components assembled together and functioning as to perform in the new role and purpose that has been described throughout. The lighting system invention described herein claims nothing new with respect to LED technology certainly. The plethora of LED technology only serves to widen the potential forms of configuration and creative use of this lighting system as long as the overall purpose is pursued albeit tailored to each specific vehicle category.

In FIGS. 15 and 16A-C light source housings 1, as described above, each having a highly reflective material 2 fitted within said housing. Mounted within said reflective material is one or more LEDs 4. Each housing 1 is also fitted with a durable impact resistant clear, non-filtering but potentially magnifying lens of glass or translucent glass, poly-carbonate or other suitable material 3 through which, a flood of normally non-colored or white light will pass. Light source housings 1 are thermally conductive, highly durable and weather resistant and are fitted with mounting hardware 5 that allows for a range of tilting and turning positions via the adjustment bolt 6. Light source housings may also be fitted with additional mounting hardware on one or more sides simultaneously as to further limit movement and create a more strongly fixed position.

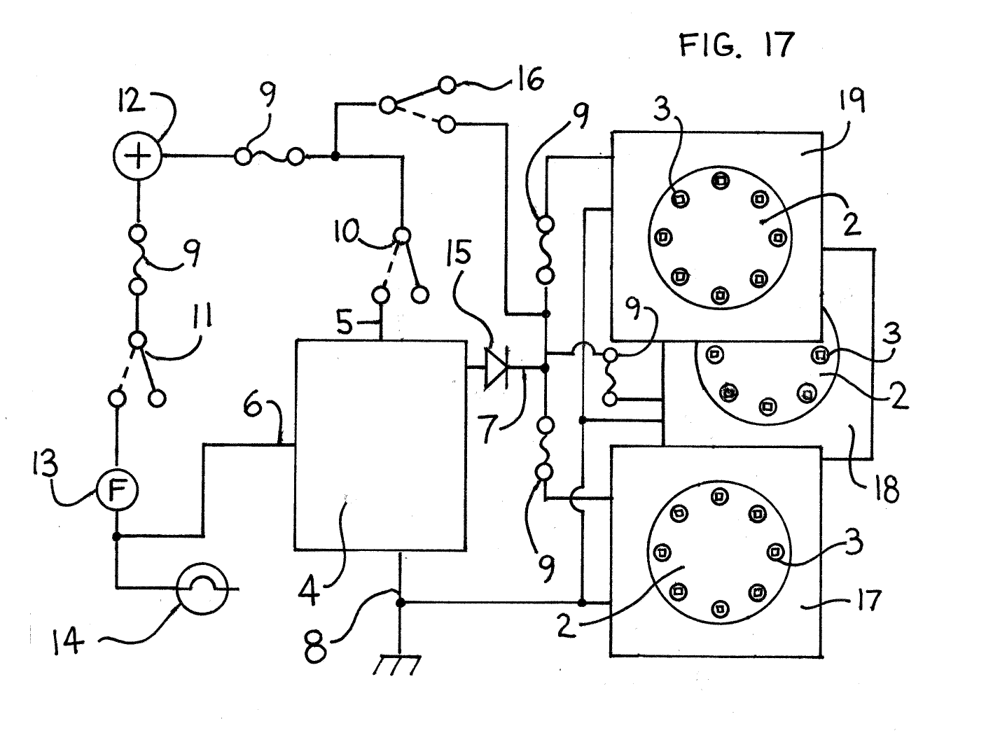

In the general diagram of FIG.17, the components and simple connections necessary for a vehicle are seen (plus or minus the quantity of light sources 17 18 19 shown). In this diagram two ways of actuating the system light sources are illustrated, via a controller 4, and/or a dedicated independent manual switch 16. The controller method is to allow the system light sources 17 18 19 to actuate with only one motion on the part of the driver, that being the actuation of the turn signal 11. The controller 4 is shown with four leads connected to it, 5 6 7 and 8 respectively. The controller 4 can be a microprocessor, common relay or time delay relay (TDR). This diagram depicts a TDR with lead 5 connected to the vehicle's headlight/marker light circuit 10, as a source of constant current as it is itself receiving power from the battery 12. The intermittent or trigger lead 6 is the turn signal circuit switch 11 including the flasher 13 which, when actuated, will trigger the relay to open to the constant current lead 5 which then supplies constant current through the output lead 7, passing through a diode 15 and illuminates the system light sources 17 18, and 19 until the timeout occurs when the turn signal switch circuit 11 is cancelled. The current may flow to the light sources for likely one second (or a fraction thereof) longer after the turn signal 11(trigger circuit) is cancelled when using a TDR because of the delay period, which is adjustable. The various circuits are protected with fuses 9 on each. The diode 15, and fuses 9, are in place to prevent damage to the controller 4 from back-feed should a short occur somewhere on the dedicated independent circuit 16 or other downstream source. The purpose of the dedicated independent circuit 16 is to allow for illumination without actuating the turn signal lamps, such as may be desired during a roadside repair for example. Choosing the headlamp/marker lamp circuit 10 as the constant supply is logical too because the invention light sources are needed only at night or in poor visibility, only occasions when the headlamps would be on as well. Again, the dedicated independent switch 16 allows for direct electrification bypassing the controller if so desired.

The light sources depicted are LED flood lights 3 set in a highly reflective material 2 which is mounted within and housed 17 18 19 in a thermally conductive material such as an aluminum alloy or other suitable material which is fitted with a high impact and durable lens (not shown) through which light is dispensed, and said light source housings are mounted to the desired location(s) on the vehicle(s). The power source 12 is the vehicle battery, the ground lead is 8 and turn signal bulb is indicated at 14. In order to maintain power to at least half the system in the event of a controller 4 failure, it is desirable that a separate controller 4 with its own power source/trigger sources be used for each side of the vehicle or combination thereof. This also works well in practice because most large vehicles and combinations thereof do in fact have separate marker and signal lamp circuit wiring for each side of the vehicle.

NOTE: Three light sources are shown in FIG. 17 to communicate in the diagram the three desired illumination zones or areas of importance for efficient use of the illumination invention's desired function on more lengthy or combination vehicles that articulate (see FIGS.1 2 3 4 and 23A-B) wherein the off-tracking problem is most exaggerated. They are identified as (a) Pre-Light, (b) Axle-Tracking and (c) Rear Body Profile.

The quantity of light sources shown in the diagram is not intended to limit or fix the lighting system in any way to the quantity shown in the diagram. While the flow of current and general circuitry is the same, the quantity of light sources and types of controllers would be normal variants of the core approach of the system diagramed while the overall function and use thereof remains the same.

In FIGS. 18A-B enlarged side and bottom views of a preferred embodiment (also in FIGS. 5A-B) wherein the two illustrations are of the same scale and should be viewed together. The illustrated light source housing 1 containing one or more LEDs 10, which are mounted into a highly reflective material 11 having a glare-shield 2 of thin metal or polymeric material and is an extension or attachment of the housing at the outer edge of the light source housing's face 1. Said light source housing 1 is attached to a portion of reinforced material 8 by means of a hinge-pin style mounting hardware 20 that enables the light source to change position by tilting. The light source housing 1 has two threaded studs 4 seated within the housing that extend through a slotted track 6 that is located on the side shields 3 that serve as structural strength components as well as glare-shields. The studs 4 have tightening wheels 5 on each that tighten from the outside surface of each side-shield 3. The tightening wheels 5 allow for loosening, position change and retightening when necessary. The light source controller 14, with its four leads is shown inside a weather-proof box 13. Two fuses 15 are present on the output line that supplies current to the light sources on the side of the vehicle where the unit is located. There are two current leads depicted to supply power to light sources, 19 for illustrated light and 18 for one or more others such as a rear-edge profile, or pre-light sources. The constant power supply lead 16 and intermittent or trigger line 17 is indicated as entering the controller 14, a relay in this illustration. Both the light source 1 and controller housing box 13 are together mounted to the base plate 7 that is intended to make contact with the underside of a commercial trailer floor or floor supports, or other suitable mounting component. The curved portion 9 of said base plate is present to facilitate ease of sliding when said is fitted with a reinforced bracket (see FIGS. 5A-B#13) whereby the light source apparatus as a whole is connected to the sliding axle carriage which is repositionable. (see: FIGS. 5A-B #7 and 8) The light source 1 is grounded 12, as is the controller also 21.

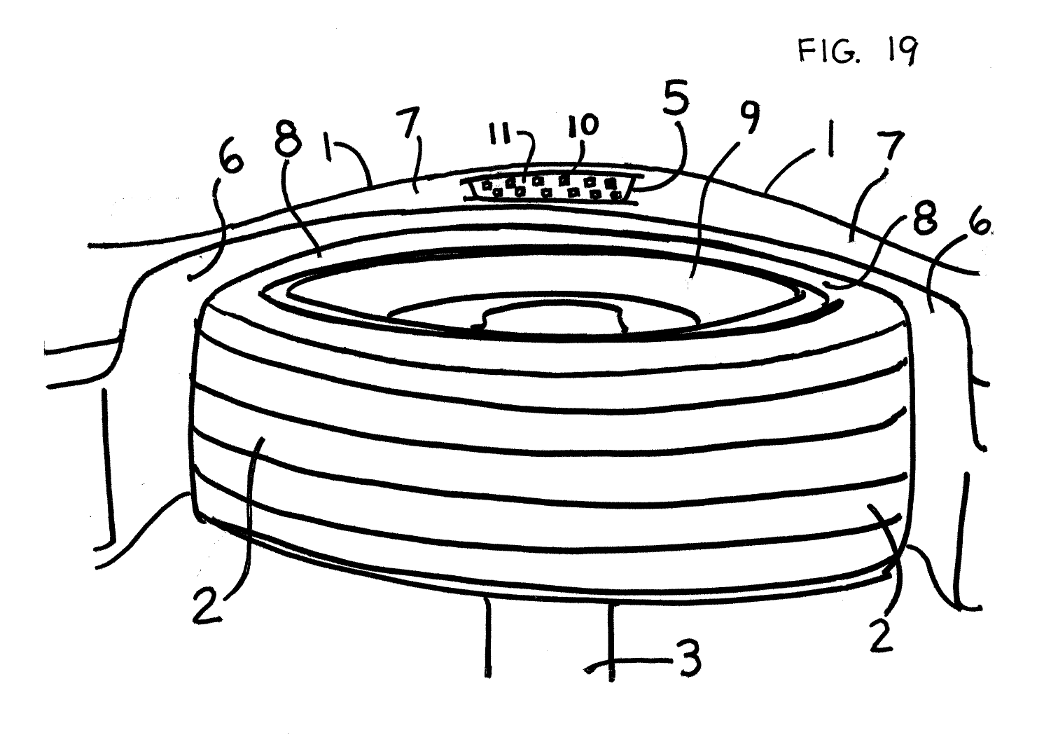

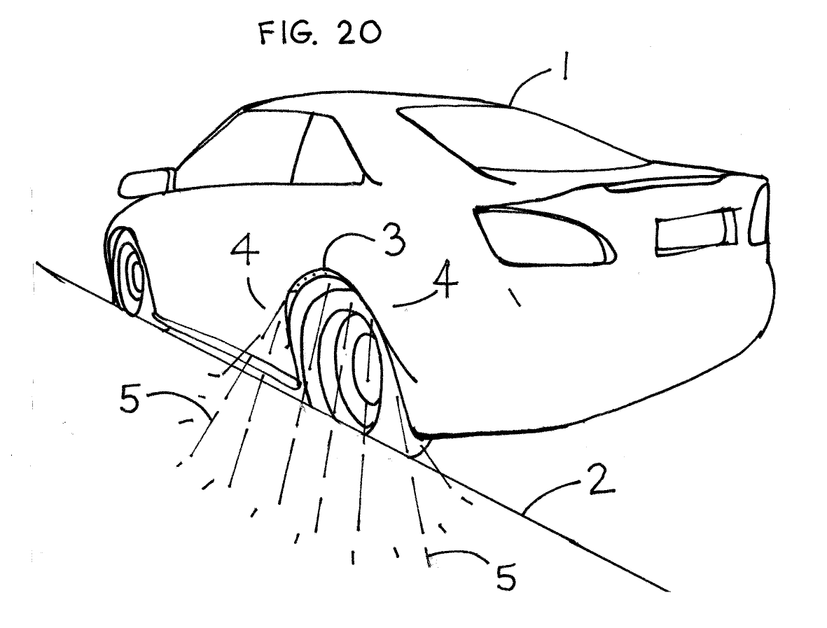

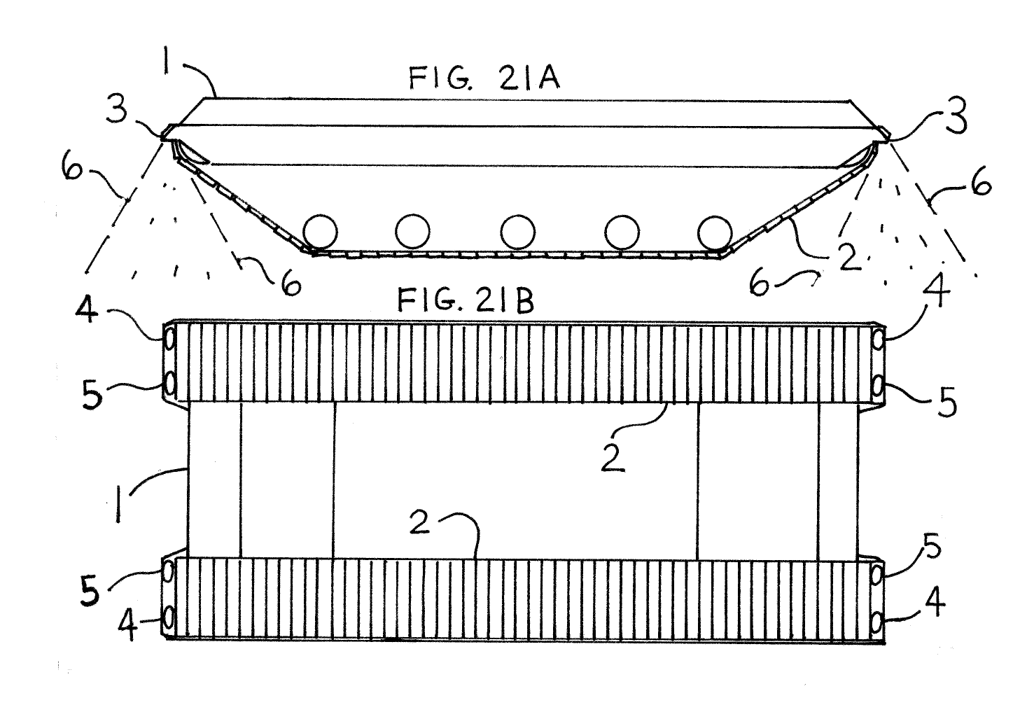

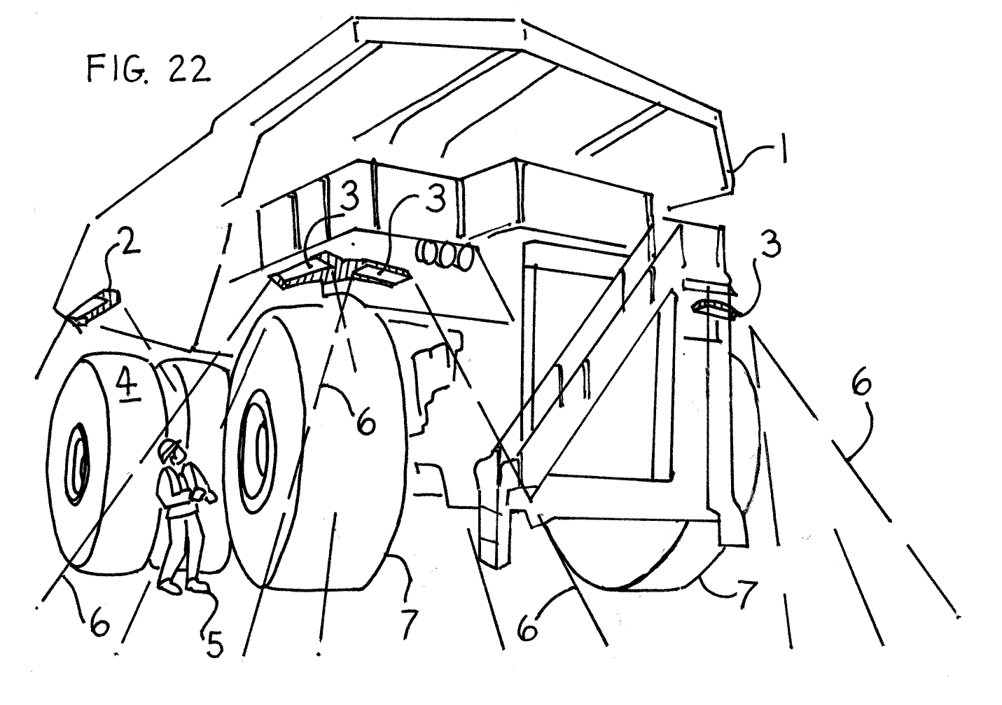

The illustration of FIG. 19 contains another preferred embodiment of the lighting system as generally applied to an automobile. With the automobile the benefits derived and intended from the use of the lighting system is of course less a matter of safety generally speaking and more an improvement to convenience when parking. There are clearly some safety and accident management benefits derived certainly, but less so. From this perspective, the bottom view of a wheel well opening 6, and the contoured outer edge radial flair 1 of the fender opening 7 that is part of the body just above the outside portion of the vehicle's tire sidewall 8, tread 2, wheel 9 and axle 3 is illustrated. In this preferred form-specific embodiment the light source housing 5, itself constructed of a suitable durable weatherproof material having within it LEDs 10 set in a highly reflective material 11, is built into the fender opening with its lens facing generally downward and a bit outward. Said lens is flush with, or alternatively recessed into the downward facing surface of the fender opening in order to be non-obvious to others. Although not depicted, another form of preferred embodiment would be located outside of the inside fender area and would be alternatively disposed around the opening, or at one or more points on the body exterior on the rear quarter panel (FIG. 20#4). Optionally, multiple light sources may be employed and arrayed in some way as to enhance attractiveness such as being shaped as a “lightning bolt” for example, while serving the same function of rear wheel position and pathway illumination. Although only one side of the vehicle is shown in the illustration, like all embodiments of the lighting system, it is intended that both sides of vehicles be equally fitted with light sources in normal circumstances.

In the illustration in FIG. 20 another perspective view of the form-specific preferred embodiment of FIG. 19 is demonstrated in use. The field of illumination 5 is depicted as emanating from the inside surface of the fender opening 3 near the outer edge so illumination can also shine on the tire sidewall face. Said field of illumination is projected onto the curb surface below, and adjacent to, the left side and rear portion of a small automobile 1. The lumen output from this embodiment should be 50 lumens and above with a radius of illumination being from one or more feet from the outside surface of the tire sidewall on either side of the automobile. In this illustration the open area of the rear quarter panel 4 is an optionally ideal place for an alternative embodiment of the light sources where they are arrayed in such a way to improve aesthetics, such as a crescent or slash for example, molded into the body and improving attractiveness while functioning as needed.

The FIGS. of 21A and 21B are side and bottom view illustrations of a track vehicle body 1 with a preferred embodiment of the lighting system mounted within the underside of the metal debris shields 3 at the end of each track 2. The light sources 4 and 5 are like the other embodiments in that they are of an extreme duty class, shock, moisture and weather resistant but with military grade lenses and components of a greater thickness and durability as well. The inside light source 5 is intended to dispense a red colored light field 6 for low light operations whereas the outer light source 4 is intended to dispense white or clear field of illumination 6. Alternatively, both light sources may be in a tandem configuration, one in front of the other, and shaped differently with both lenses being up to as wide as the track debris shields 3 can accommodate. Unlike with other embodiments, the illumination from the light sources would not likely be easily visible to the driver but would serve a more narrow purpose. The purpose of the system as applied to a military track vehicle is more to alert military personnel proximate as to the exact position and pathway of the tracks 2 via the light produced 6 from above the tracks. This illumination serves to increase safety during operations. During such operations which are executed in all conditions like darkness, dust storms, and fog etc., persons proximate are unable to identify the tracks. To enable the track vehicle to operate with the additional capacity to illuminate the tracks is a benefit. Light sources in these locations can also assist with inspecting the condition, or maintenance of the tracks. Optionally, the embodiment could include an array of light sources disposed along the outer edge of the debris shields over the tracks on both sides of the vehicle. This embodiment effectively illuminates the entire track and vehicle suspension area along with a portion of the ground surface.

In the illustration of FIG. 22, an embodiment like that of FIG. 11 wherein multiple large bar style LED flood lamps that protrude is depicted in use on a super-transfer truck 1. A worker 5 standing to the side of one of the huge front tires 7 is standing within a safety zone created by the illumination fields 6. Due to the incredible size of the tires and visual disadvantage of the driver to see objects and persons in certain zones around the vehicle, the lighting system is intended to increase visibility for all parties by the vastly improved visual identification of the equipment and pathway. The rear lamps themselves 2 are disposed at points above the rear tires tread (unseen but like 3) and also at the sidewall 4. The front light sources 3 are mounted above the front tires 7 and like the rear light sources are configured and mounted in such a way to provide forward tread illumination, side illumination and a large area of ground surface area. Each end of both axles would preferably have at least one light source for that area. These light sources are also of an extremely durable caliber with a preferred lumen output rating of 2000 or more.

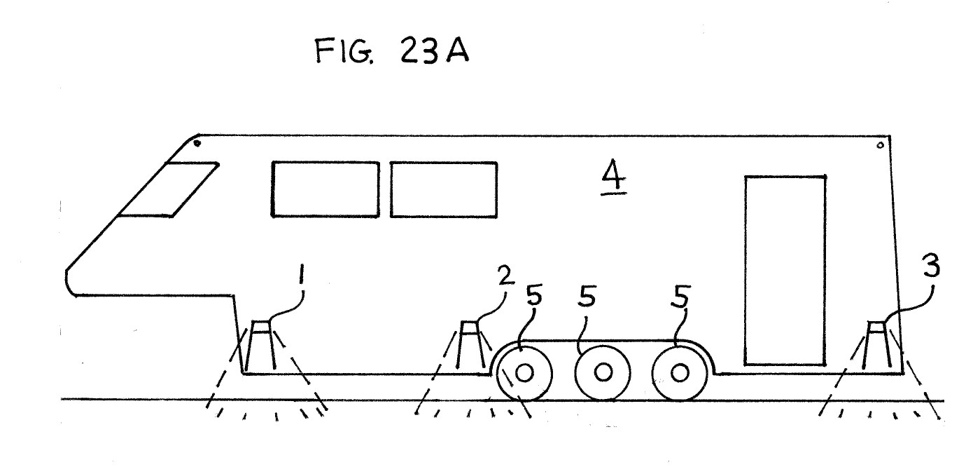

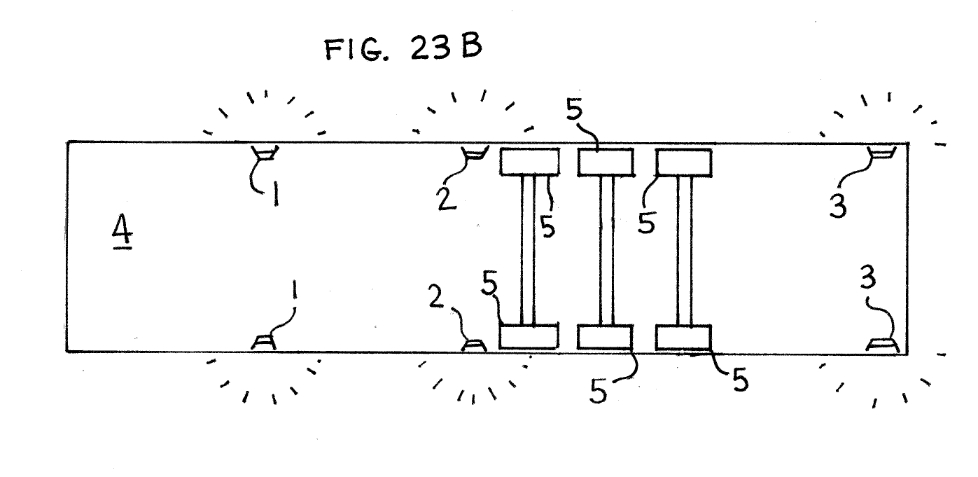

The illustration of FIGS. 23A and 23B depict another potential use and preferred embodiment that is of the types described in FIGS. 11 and 12. In this illustration however the recessed variety of form-specific LED flood light sources, is shown in each of the three critical zones: 1, pre-lighting zone, 2 axle-tracking zone, and 3 rear-edge profile zone. The vehicle shown is a three-axle 5 RV trailer 4. Said vehicle is an articulating vehicle intended to be used as one of a combination of vehicles, and like all such vehicles, is also characterized by “off-tracking”. The light sources illustrated for this application and those like it would preferably have a lumen range of at least 200 or more each.

1. A lighting system for a vehicle or combination of vehicles sides, undersides, rear trailing axles, wheels, and/or rear body portion comprised of one or more light sources housed in a durable weatherproof housing, having a transparent lens through which light is projected, being mounted onto, or built into, at least one portion of a vehicle's (a) body (b) chassis (c) trim (d) framework, along with optional position adjustment components, whereby said light sources are specifically arranged to project a sufficiently bright field of light in a generally downward direction onto one or more areas of the vehicle(s) sides, undersides, rear or trailing wheels and tires, rear body portion(s), and the ground surface proximate to such upon actuation via wired circuit and/or wireless signal originating from one or more system controllers and/or switches, either combined within each light source housing in its place of mounting effectively constituting an independent and complete illumination pod, nondependent upon other such pods, or alternatively located and integrated within the vehicle(s) main electrical platform, or a combination of both, so that by actuation of the lighting sources, sufficient illumination is produced specifically onto the desired aforementioned area(s), thus making said areas much more clearly visible to the driver through the vehicle windows and/or via the side mounted rear-view mirrors enabling a greater degree of control and safety while maneuvering resulting from improved visual cognition in darkness or poor visibility.

2. A lighting system for a vehicle or combination of vehicles' sides, undersides, rear or trailing wheels and/or rear body portion of claim 1, further characterized in that said light sources are comprised of at least one or more light emitting diodes, or LEDS.

3. A lighting system for a vehicle or combination of vehicles' sides, undersides, rear or trailing wheels and/or rear body portion of claims 1 and 2, further characterized in that said LED light source housings are thermally conductive and are comprised of one or more (a) metal alloy materials, (b) polymeric materials, (c) polycarbonate materials, or a combination thereof.

4. A lighting system for a vehicle or combination of vehicles' sides, undersides, rear or trailing wheels and/or rear body portion of claims 1 through 3, further characterized in that said LED light source housing(s) form is expressed in either a (a) form-specific fashion, that being designed for integration into and as part of the vehicle form and contour or, (b) non form-specific and non-integrating, but independent of, with respect to its shape relative to the surrounding or nearby vehicle body form or contour.

5. A lighting system for a vehicle or combination of vehicles' sides, undersides, rear or trailing wheels and/or rear body portion of claims 1 through 4, further characterized in that said non form-specific and form-specific LED light source housings, controllers, and described system components are attached to the vehicle(s) by means of durable (a) clamp-on methods and materials, (b) bolt-on methods and materials, (c) adhesive-held methods and materials, (d) snap-on methods and materials, (e) welded support methods and materials.

6. A lighting system for a vehicle or combination of vehicles' sides, undersides, rear or trailing wheels and/or rear body portion of claims 1 through 5, further characterized in that both non-form specific and form-specific LED light sources and/or housings, if not mounted in a fixed position as to light direction, can alternatively and optionally adjust light direction from 270° forward illumination to 90° rearward illumination by means of an (a) hinge style tilting mechanism, (b) swiveling mechanism, (c) ball and socket style mechanism, or any combination thereof with any such mechanism being fastened to the vehicle(s) in one or more of the ways listed in claim 5.

7. A lighting system for a vehicle or combination of vehicles' sides, undersides, rear or trailing wheels and/or rear body portion of claims 1 through 6, further characterized in that at least one of said LED light source(s), whether form-specific or non form-specific, along with selected mounting components, is either (a) affixed onto or into the vehicle in a stationary location, or (b) alternatively repositionable along or under the vehicle by means of an axle carriage connective component that repositions the system light source(s) and necessary components simultaneously as the axle carriage is itself repositioned.

8. A lighting system for a vehicle or combination of vehicles' sides, undersides, rear or trailing wheels and/or rear body portion of claims 1 through 7, further characterized in that illumination of said LED light sources is controlled or actuated by at least one (a) dedicated independent manual switch, (b) time-delay relay (TDR), (c) common vehicle relay, (d) wireless transmitter-receiver, (e) photocell switch, (f) motion sensor switch (g) microprocessor, or combination thereof.

9. A lighting system for a vehicle or combination of vehicles' sides, undersides, rear or trailing wheels and/or rear body portion of claims 1 through 8, further characterized in that each of said LED light sources preferably have a level of illumination, as measured in luminous flux, of at least 50 lumens or more, with voltage of said being from at least 6 to 24V DC, with amperage draw of at least 0.085 milliamps or more.

10. A lighting system for a vehicle or combination of vehicles' sides, undersides, rear or trailing wheels and/or rear body portion of claims 1 through 9, further characterized in that said LED lighting system components are supplied electricity by, and operate in concurrence with the vehicle(s) (a) battery, (b) constant marker light circuit, (c) headlamp circuit, (d) intermittent turn signal circuit, or combination thereof via suitable conductive and weather resistant connections and/or by wireless means.

11. A lighting system for a vehicle or combination of vehicles' sides, undersides, rear or trailing wheels and/or rear body portion of claims 1 through 10, further characterized in that the individual pod referenced within claim 1 is a sealed, complete, and self contained unit having its own individual controller and operable by one or more methods described in claim 8, being suited for independent operation for its purpose when actuated, and allows replacement of said without harm or change to remaining pods.
